(19) United States
(12) Patent Application Publication
(10) Pub. No.: US 2026/0063933 A1
(43) Pub. Date: Mar. 5, 2026

(54) OPTICAL MODULATOR, OPTICAL TRANSMITTER, AND OPTICAL TRANSCEIVER

(71) Applicant: FUJITSU OPTICAL COMPONENTS LIMITED, Kawasaki-shi (JP)

(72) Inventor: Kazumasa SATO, Chigasaki (JP)

(73) Assignee: FUJITSU OPTICAL COMPONENTS LIMITED, Kawasaki-shi (JP)

(21) Appl. No.: 19/059,666

(22) Filed: Feb. 21, 2025

(30) Foreign Application Priority Data
Aug. 29, 2024 (JP) 2024-147655

(51) Int. Cl. G02F 1/035; G02F 1/21; G02F 1/225; H04B 10/516

(52) U.S. Cl. CPC G02F 1/035; G02F 1/212; G02F 1/225; G02F 2202/20; H04B 10/516

(57) ABSTRACT

An optical modulator includes a first coupler that splits signal light into two beams of light, a first waveguide that is connected to one output of the first coupler, a second waveguide that is connected to another output of the first coupler, and a second coupler that couples signal light coming from the first waveguide and the second waveguide and outputs coupled light. The first waveguide includes a first input-side arm waveguide, a first output-side arm waveguide, and a first folded waveguide. The second waveguide includes a second input-side arm waveguide, a second output-side arm waveguide, and a second folded waveguide. The first and second input-side arm waveguides and the first and second output-side arm waveguides are waveguides that include a material with high EO characteristics. The first and second folded waveguides are waveguides that include a material (SiN) with a low refractive index.

### CROSS-REFERENCE TO RELATED APPLICATION

This application is based upon and claims the benefit of priority of the prior Japanese Patent Application No. 2024-147655, filed on Aug. 29, 2024, the entire contents of which are incorporated herein by reference.

### FIELD

The embodiments discussed herein are related to an optical modulator, an optical transmitter, and an optical transceiver.

### BACKGROUND

For example, a thin-film LN modulator using a thin-film LN as an optical modulator that is able to perform high-efficiency and high-speed operation is known. However, in the thin-film LN modulator, it is generally needed to set a modulator length to 10 millimeters (mm) or more to realize high efficiency (low half-wave voltage Vπ), and there is a problem with downsizing.

Therefore, as a means for solving the problem as described above, a structure in which a thin-film LN modulator that is made of a different material is integrated on an Si photonics substrate and a part of functions of an optical modulator, such as a DC phase shifter, is implemented by Si photonics that is suitable for downsizing is known (CLEO 2023 STh40.5). Furthermore, a structure in which a thin-film LN modulator that is made of a different material is integrated on an Si photonics substrate and an arm waveguide of an optical modulator is folded to reduce a size in a longitudinal direction is known (2021 IEEE 17th International Conference on Group IV Photonics 10.1109/IEDM19573.2019.8993510).

FIG. 25 is a schematic plan view illustrating an example of a conventional optical modulator 500. The optical modulator 500 illustrated in FIG. 25 is a thin-film LN modulator that has a folded structure and that is mounted on an Si photonics substrate 501. The optical modulator 500 includes the Si photonics substrate 501, an input Multi-Mode Interferometer (MMI) 502, a modulator main body 503, and a folded portion 504. The input and output MMI 502 includes an input waveguide 502A that inputs input light to the modulator main body 503, and an output waveguide 502B that outputs signal light from the modulator main body 503. The optical modulator 500 includes an input coupler 510, a first waveguide 520, a second waveguide 530, an output coupler 540, and an electrode 550. The input coupler 510 is a coupler that splits the input light coming from the input waveguide 502A into two beams of input light, outputs one of the divided beams of input light to the first waveguide 520, and outputs the other one of the divided beams of input light to the second waveguide 530. The output coupler 540 is a coupler that couples signal light coming from the first waveguide 520 and signal light coming from the second waveguide 530 and outputs the coupled light to the output waveguide 502B. The electrode 550 has a GSG structure that includes a single signal electrode 551 and two ground electrodes 552. The signal electrode 551 includes a straight signal electrode 551A and a folded signal electrode 551B. Each of the ground electrodes 552 include straight ground electrodes 552A and folded ground electrodes 552B.

The first waveguide 520 includes a first input waveguide 521, a first input-side arm waveguide 522, a first folded waveguide 523, a first output-side arm waveguide 524, and a first output waveguide 525. The first input waveguide 521 is a waveguide that connects between the input coupler 510 and the first input-side arm waveguide 522. The first output waveguide 525 is a waveguide that connects between the output coupler 540 and the first output-side arm waveguide 524. The first folded waveguide 523 is a bent waveguide that connects between the first input-side arm waveguide 522 and the first output-side arm waveguide 524. The first input-side arm waveguide 522 is a straight arm waveguide that modulates signal light by changing a refractive index of the signal light to be guided, in accordance with an electrical signal that comes from the signal electrode 551 to the ground electrode 552. The first output-side arm waveguide 524 is a straight arm waveguide that modulates signal light by changing a refractive index of the signal light to be guided, in accordance with an electrical signal that comes from the signal electrode 551 to the ground electrode 552. Meanwhile, the signal electrode 551 is arranged in the vicinity of one side surfaces of the first input-side arm waveguide 522 and the first output-side arm waveguide 524, and the ground electrodes 552 are arranged in the vicinity of the other side surfaces of the first input-side arm waveguide 522 and the first output-side arm waveguide 524. The first input waveguide 521, the first folded waveguide 523, and the first output waveguide 525 are configured with Si waveguides, and the first input-side arm waveguide 522 and the first output-side arm waveguide 524 are configured with thin-film LN waveguides.

The second waveguide 530 includes a second input waveguide 531, a second input-side arm waveguide 532, a second folded waveguide 533, a second output-side arm waveguide 534, and a second output waveguide 535. The second input waveguide 531 is a waveguide that connects between the input coupler 510 and the second input-side arm waveguide 532. The second output waveguide 535 is a waveguide that connects between the output coupler 540 and the second output-side arm waveguide 534. The second folded waveguide 533 is a bent waveguide that connects between the second input-side arm waveguide 532 and the second output-side arm waveguide 534. The second input-side arm waveguide 532 is a straight arm waveguide that modulates signal light by changing a refractive index of the signal light to be guided, in accordance with an electrical signal that comes from the signal electrode 551 to the ground electrode 552. The second output-side arm waveguide 534 is a straight arm waveguide that modulates signal light by changing a refractive index of the signal light to be guided, in accordance with an electrical signal that comes from the signal electrode 551 to the ground electrode 552. Meanwhile, the signal electrode 551 is arranged in the vicinity of one side surfaces of the second input-side arm waveguide 532 and the second output-side arm waveguide 534, and the ground electrodes 552 are arranged in the vicinity of the other side surfaces of the second input-side arm waveguide 532 and the second output-side arm waveguide 534. The second input waveguide 531, the second folded waveguide 533, and the second output waveguide 535 are configured with Si waveguides, and the second input-side arm waveguide 532 and the second output-side arm waveguide 534 are configured with thin-film LN waveguides.
Patent Literature 1: International Publication Pamphlet No. 2008/099950
Patent Literature 2: U.S. Patent Application Publication No. 2022/404652

In the conventional optical modulator 500, the first input-side arm waveguide 522, the first output-side arm waveguide 524, the second input-side arm waveguide 532, and the second output-side arm waveguide 534 are configured with thin-film LN waveguides. Furthermore, in the optical modulator 500, the first folded waveguide 523 and the second folded waveguide 533 are configured with Si waveguides. To realize high-speed operation of the optical modulator 500, it is needed to match a propagation velocity of light that propagates through the optical modulator 500 with a propagation velocity of an electrical signal, that is, it is needed to perform velocity matching, and basically, it is designed such that a refractive index of the light and a refractive index of the electrical signal coincide with each other.

FIG. 26 is a diagram for explaining an example of a relationship between a refractive index and a waveguide width in an Si waveguide and a signal electrode. In the first folded waveguide 523 and the second folded waveguide 533, Si waveguides are used, and, as illustrated in FIG. 26, a refractive index of the Si waveguide is about 4 and a refractive index of the signal electrode is about 1.9. Therefore, a velocity difference occurs between a propagation velocity of light that is guided by the Si waveguide and a propagation velocity of an electrical signal that comes through the signal electrode.

To ensure velocity matching, it is needed to match an optical path length, which is a product of a waveguide length L and a refractive index n (n×L), between the light and the electrical signal, and therefore, it is needed to increase an electrode length of the signal electrode by 4/1.9 that is a ratio of the refractive indices, that is, about twice, as compared to a waveguide length. As a result, a size of the folded signal electrode 551B that is arranged on each of side surfaces of the first folded waveguide 523 and the second folded waveguide 533 is increased, so that a size of the entire optical modulator 500 is increased.

### SUMMARY

According to an aspect of an embodiment, an optical modulator includes a substrate that includes a high refractive index waveguide, a first coupler that is arranged on the substrate and that splits signal light into two beams of light, a first waveguide that is arranged on the substrate and that is connected to one output of the first coupler, a second waveguide that is arranged on the substrate and that is connected to another output of the first coupler, a second coupler that is arranged on the substrate, that couples signal light coming from the first waveguide and signal light coming from the second waveguide, and that outputs the coupled signal light, and an electrode that applies an electrical signal to the first waveguide and the second waveguide. The first waveguide includes a first input-side arm waveguide that is connected to the first coupler, a first output-side arm waveguide that is connected to the second coupler, and a first folded waveguide that connects between the first input-side arm waveguide and the first output-side arm waveguide. The second waveguide includes a second input-side arm waveguide that is connected to the first coupler, a second output-side arm waveguide that is connected to the second coupler, and a second folded waveguide that connects between the second input-side arm waveguide and the second output-side arm waveguide. The first input-side arm waveguide, the second input-side arm waveguide, the first output-side arm waveguide, and the second output-side arm waveguide are waveguides that include a material with high EO characteristics as compared to the high refractive index waveguide. At least a part of the first folded waveguide and the second folded waveguide is a waveguide that includes a material with a low refractive index as compared to the high refractive index waveguide.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic plan view illustrating an example of an optical modulator of a first embodiment;

FIG. 2 is a schematic plan view illustrating an example of a folded portion;

FIG. 3 is a schematic cross-sectional view illustrating an example of the optical modulator;

FIG. 4 is a perspective view illustrating an example of a first folded waveguide and a second folded waveguide at an intersection;

FIG. 5 is a schematic plan view illustrating an example of a first input-side transition unit;

FIG. 6A is a schematic cross-sectional view illustrating an example of a cross-sectional portion taken along a line A-A illustrated in FIG. 5;

FIG. 6B is a schematic cross-sectional view illustrating an example of a cross-sectional portion taken along a line B-B illustrated in FIG. 5;

FIG. 6C is a schematic cross-sectional view illustrating an example of a cross-sectional portion taken along a line C-C illustrated in FIG. 5;

FIG. 6D is a schematic cross-sectional view illustrating an example of a cross-sectional portion taken along a line D-D illustrated in FIG. 5;

FIG. 7 is a schematic plan view illustrating an example of a first input-side first-stage transition unit;

FIG. 8A is a schematic cross-sectional view illustrating an example of a cross-sectional portion taken along a line A-A illustrated in FIG. 7;

FIG. 8B is a schematic cross-sectional view illustrating an example of a cross-sectional portion taken along a line B-B illustrated in FIG. 7;

FIG. 8C is a schematic cross-sectional view illustrating an example of a cross-sectional portion taken along a line C-C illustrated in FIG. 7;

FIG. 8D is a schematic cross-sectional view illustrating an example of a cross-sectional portion taken along a line D-D illustrated in FIG. 7;

FIG. 9 is a schematic cross-sectional view illustrating an example of a cross-sectional portion taken along a line A-A illustrated in FIG. 1;

FIG. 10 is a diagram for explaining an example of a relationship between a refractive index and a waveguide width in an Si waveguide, a SiN waveguide, and a signal electrode;

FIG. 11 is a diagram for explaining an example of a comparison result of an optical path length and an electrode length of a folded portion among the first embodiment, a first comparative example, and a second comparative example;

FIG. 12 is a perspective view illustrating an example of a first folded waveguide and a second folded waveguide at an intersection of an optical modulator of a second embodiment;

FIG. 13 is a schematic cross-sectional view illustrating an example of a folded portion of an optical modulator of the second embodiment;

FIG. 14 is a schematic plan view illustrating an example of a first input-side first-stage transition unit and a first input-side second-stage transition unit in the first folded waveguide;

FIG. 15A is a schematic cross-sectional view illustrating an example of a cross-sectional portion taken along a line A-A illustrated in FIG. 14;

FIG. 15B is a schematic cross-sectional view illustrating an example of a cross-sectional portion taken along a line B-B illustrated in FIG. 14;

FIG. 15C is a schematic cross-sectional view illustrating an example of a cross-sectional portion taken along a line C-C illustrated in FIG. 14;

FIG. 15D is a schematic cross-sectional view illustrating an example of a cross-sectional portion taken along a line D-D illustrated in FIG. 14;

FIG. 16 is a schematic plan view illustrating an example of an optical modulator of a third embodiment;

FIG. 17 is a schematic cross-sectional view illustrating an example of a cross-sectional portion taken along a line A-A illustrated in FIG. 16;

FIG. 18 is a schematic plan view illustrating an example of an optical modulator of a fourth embodiment;

FIG. 19 is a diagram for explaining an example of a DP-IQ modulator of a fifth embodiment;

FIG. 20 is a diagram for explaining an example of an optical transceiver of a sixth embodiment;

FIG. 21 is a schematic cross-sectional view illustrating an example of an optical transceiver;

FIG. 22A is a schematic cross-sectional view illustrating an example of an Si photonics substrate that is subjected to a first formation process;

FIG. 22B is a schematic cross-sectional view illustrating an example of the Si photonics substrate that is subjected to a second formation process;

FIG. 22C is a schematic cross-sectional view illustrating an example of the Si photonics substrate that is subjected to a first removal process;

FIG. 22D is a schematic cross-sectional view illustrating an example of the Si photonics substrate that is subjected to a third formation process;

FIG. 22E is a schematic cross-sectional view illustrating an example of the Si photonics substrate that is subjected to a second removal process;

FIG. 22F is a schematic cross-sectional view illustrating an example of the Si photonics substrate that is subjected to a fourth formation process;

FIG. 22G is a schematic cross-sectional view illustrating an example of the Si photonics substrate that is subjected to a fifth formation process;

FIG. 22H is a schematic cross-sectional view illustrating an example of the Si photonics substrate that is subjected to a sixth formation process;

FIG. 22I is a schematic cross-sectional view illustrating an example of the Si photonics substrate that is subjected to a seventh formation process;

FIG. 23 is a diagram for explaining an example of an optical module of a seventh embodiment;

FIG. 24 is a diagram for explaining an example of an optical transceiver of an eighth embodiment;

FIG. 25 is a schematic plan view illustrating an example of a conventional optical modulator; and

FIG. 26 is a diagram for explaining an example of a relationship between a refractive index and a waveguide width in an Si waveguide and a signal electrode.

### DESCRIPTION OF EMBODIMENTS

Preferred embodiments of the present invention will be explained with reference to accompanying drawings. Meanwhile, the present invention is not limited by the embodiments below. In addition, the embodiments described below may be appropriately coupled as long as no contradiction is derived.

### (a) First Embodiment

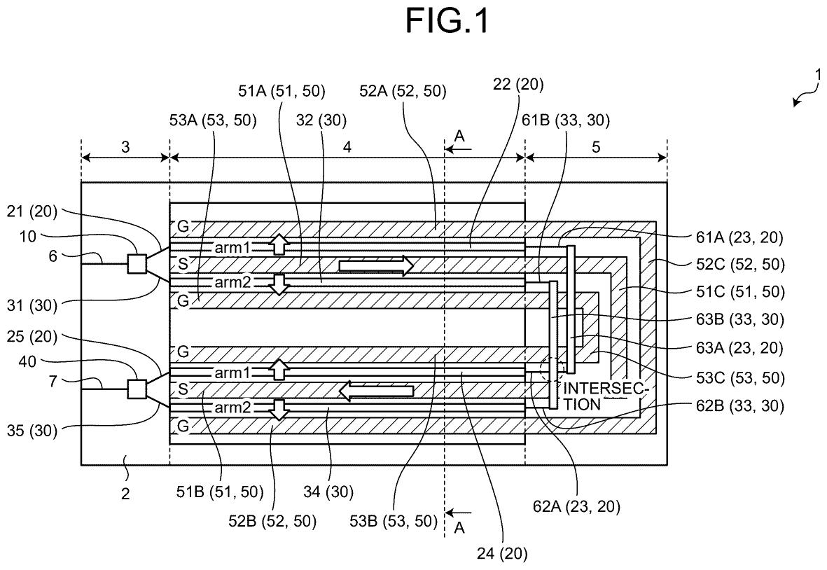

FIG. 1 is a schematic plan view illustrating an example of an optical modulator 1 of a first embodiment. The optical modulator 1 illustrated in FIG. 1 is a modulator chip in which a thin-film LN optical modulator of a Mach-Zehnder type is mounted on an Si photonics substrate 2. The optical modulator 1 includes the Si photonics substrate 2, an input output Multi-Mode Interferometer (MMI) 3, a modulator main body 4, and a folded portion 5. The input output MMI 3 includes an input waveguide 6 that inputs input light to the modulator main body 4, and an output waveguide 7 that outputs signal light coming from the modulator main body 4. The modulator main body 4 is a modulation operation unit of a Mach-Zehnder type modulator that performs optical modulation operation by applying voltage to a thin-film LN waveguide. The folded portion 5 is a portion in which an arm waveguide of the optical modulator 1 is folded.

The optical modulator 1 includes a first coupler 10, a first waveguide 20, a second waveguide 30, a second coupler 40, and an electrode 50. The first coupler 10 is a coupler that is arranged on an Si substrate 71, splits signal light coming from the input waveguide 6, and outputs the split light to a first input waveguide 21A and a second input waveguide 31A. The first waveguide 20 is arranged on the Si substrate 71 and connected to one output of the first coupler 10. The second waveguide 30 is arranged on the Si substrate 71 and connected to the other output of the first coupler 10.

The second coupler 40 is a coupler that is arranged on the Si substrate 71, couples signal light coming from a first output waveguide 25 that is arranged on an output stage of the first waveguide 20 and signal light coming from a second output waveguide 35 that is arranged on an output stage of the second waveguide 30, and outputs the coupled signal light to the output waveguide 7. The electrode 50 is a GSG electrode that applies an electrical signal to the first waveguide 20 and the second waveguide 30.

The first waveguide 20 includes a first input waveguide 21, a first input-side arm waveguide 22, a first folded waveguide 23, a first output-side arm waveguide 24, the first output waveguide 25, a first input-side modulation unit transition unit 26, and a first output-side modulation unit transition unit 27. The first input waveguide 21 is, for example, an Si waveguide that connects between the first coupler 10 and the first input-side arm waveguide 22.

The first input-side arm waveguide 22 is a straight arm waveguide that is made of a high EO material, such as thin-film LN, and that connects between the first input waveguide 21 and the first folded waveguide 23. The first folded waveguide 23 is a waveguide that has a folded structure and that connects between the first input-side arm waveguide 22 and the first output-side arm waveguide 24. The first output-side arm waveguide 24 is a straight arm waveguide that is made of a high EO material, such as thin-film LN, and that connects between the first folded waveguide 23 and the first output waveguide 25.

The first input-side modulation unit transition unit 26 includes an output end of the first input waveguide 21 and an input end of the first input-side arm waveguide 22, and allows transition of signal light between the first input waveguide 21 and the first input-side arm waveguide 22. Furthermore, the first input-side modulation unit transition unit 26 includes an output end of the first input-side arm waveguide 22 and an input end of the first folded waveguide 23, and allows transition of signal light between the first input-side arm waveguide 22 and the first folded waveguide 23.

The first output-side modulation unit transition unit 27 includes an output end of the first folded waveguide 23 and an input end of the first output-side arm waveguide 24, and allows transition of signal light between the first folded waveguide 23 and the first output-side arm waveguide 24. The first output-side modulation unit transition unit 27 includes an output end of the first output-side arm waveguide 24 and an input end of the first output waveguide 25, and allows transition of signal light between the first output-side arm waveguide 24 and the first output waveguide 25.

The second waveguide 30 includes a second input waveguide 31, a second input-side arm waveguide 32, a second folded waveguide 33, a second output-side arm waveguide 34, the second output waveguide 35, a second input-side modulation unit transition unit 36, and a second output-side modulation unit transition unit 37. The second input waveguide 31 is, for example, an Si waveguide that connects between the first coupler 10 and the second input-side arm waveguide 32.

The second input-side arm waveguide 32 is a straight arm waveguide that is made of a high EO material, such as thin-film LN, and that connects between the second input waveguide 31 and the second folded waveguide 33. The second folded waveguide 33 is a waveguide that has a folded structure and that connects between the second input-side arm waveguide 32 and the second output-side arm waveguide 34. The second output-side arm waveguide 34 is a straight arm waveguide that is made of a high EO material, such as thin-film LN, and that connects between the second folded waveguide 33 and the second output waveguide 35.

The second input-side modulation unit transition unit 36 includes an output end of the second input waveguide 31 and an input end of the second input-side arm waveguide 32, and allows transition of signal light between the second input waveguide 31 and the second input-side arm waveguide 32. The second input-side modulation unit transition unit 36 includes an output end of the second input-side arm waveguide 32 and an input end of the second folded waveguide 33, and allows transition of signal light between the second input-side arm waveguide 32 and the second folded waveguide 33.

The second output-side modulation unit transition unit 37 includes an output end of the second folded waveguide 33 and an input end of the second output-side arm waveguide 34, and allows transition of signal light between the second folded waveguide 33 and the second output-side arm waveguide 34. The second output-side modulation unit transition unit 37 includes an output end of the second output-side arm waveguide 34 and an input end of the second output waveguide 35, and allows transition of signal light between the second output-side arm waveguide 34 and the second output waveguide 35.

The first input-side arm waveguide 22, the second input-side arm waveguide 32, the first output-side arm waveguide 24, and the second output-side arm waveguide 34 are waveguides that include a material with high EO characteristics, such as LN, as compared to the Si substrate 71. Further, the first folded waveguide 23 and the second folded waveguide 33 are waveguides that include a material with a low refractive index, such as SiN, as compared to the Si substrate 71.

The first waveguide 20 includes the first input-side arm waveguide 22 that is located on an outer peripheral side of the folding, the first folded waveguide 23 that is located on an outer peripheral side of the folding, and a first output-side arm waveguide 24 that is located on an inner peripheral side of the folding.

The second waveguide 30 includes the second input-side arm waveguide 32 that is located on an inner peripheral side of the folding, the second folded waveguide 33 that is located on an inner peripheral side of the folding, the second output-side arm waveguide 34 that is located on an outer peripheral side of the folding.

The electrode 50 is an electrode that has a GSG structure and that includes a signal electrode 51, a first ground electrode 52, and a second ground electrode 53. The signal electrode 51 includes an input signal electrode 51A, an output signal electrode 51B, and a folded signal electrode 51C. The input signal electrode 51A is arranged between the first input-side arm waveguide 22 and the second input-side arm waveguide 32, and is electrically connected to the folded signal electrode 51C. The output signal electrode 51B is arranged between the first output-side arm waveguide 24 and the second output-side arm waveguide 34, and is electrically connected to the folded signal electrode 51C. The folded signal electrode 51C is arranged between the first folded waveguide 23 and the second folded waveguide 33, and electrically connects the input signal electrode 51A and the output signal electrode 51B.

The first ground electrode 52 includes a first input-side ground electrode 52A that is located on the outer peripheral side, a first output-side ground electrode 52B that is located on the outer peripheral side, and a first folded ground electrode 52C that is located on the outer peripheral side. The first input-side ground electrode 52A is arranged in the vicinity of a side surface of the first input-side arm waveguide 22 located on the outer peripheral side, so as to face the input signal electrode 51A, and is electrically connected to the first folded ground electrode 52C that is located on the outer peripheral side. The first output-side ground electrode 52B is arranged in the vicinity of a side surface of the second output-side arm waveguide 34 located on the outer peripheral side, so as to face the output signal electrode 51B, and is electrically connected to the first folded ground electrode 52C. The first folded ground electrode 52C electrically connects between the first input-side ground electrode 52A and the first output-side ground electrode 52B.

The second ground electrode 53 includes a second input-side ground electrode 53A that is located on the inner peripheral side, a second output-side ground electrode 53B that is located on the inner peripheral side, and a second folded ground electrode 53C that is located on the inner peripheral side. The second input-side ground electrode 53A is arranged in the vicinity of a side surface of the second input-side arm waveguide 32 located on the inner peripheral side, so as to face the input signal electrode 51A, and is electrically connected to the second folded ground electrode 53C that is located on the inner peripheral side. The second output-side ground electrode 53B is arranged in the vicinity of a side surface of the first output-side arm waveguide 24 located on the inner peripheral side, so as to face the output signal electrode 51B, and is electrically connected to the second folded ground electrode 53C. The second folded ground electrode 53C electrically connects between the second input-side ground electrode 53A and the second output-side ground electrode 53B.

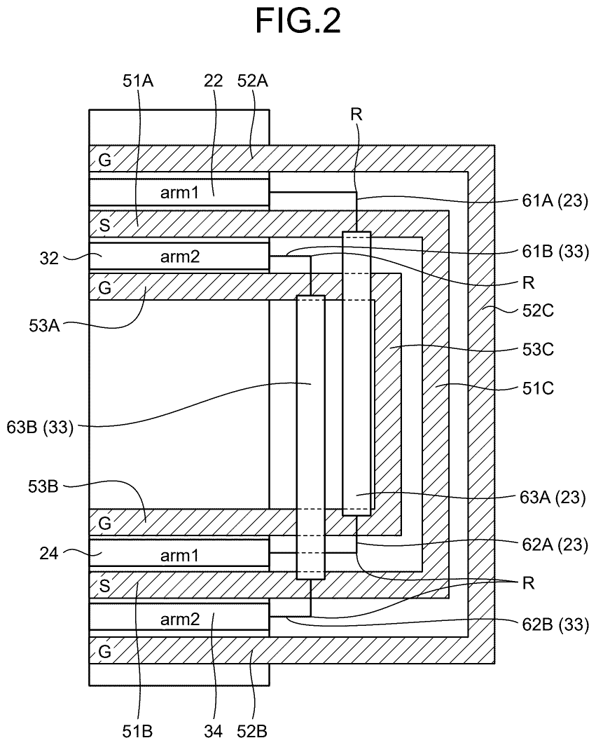

FIG. 2 is a schematic plan view illustrating an example of the folded portion 5. The folded portion 5 includes the first folded waveguide 23 and the second folded waveguide 33. The first folded waveguide 23 includes a first input-side high refractive index waveguide 61A, a first output-side high refractive index waveguide 62A, a first low refractive index waveguide 63A, a first input-side first-stage transition unit 64A1, and a first output-side first-stage transition unit 64A2. The first input-side high refractive index waveguide 61A is a waveguide that is formed on a first layer 70A on the Si substrate 71, that is connected to the first input-side arm waveguide 22, that has a core made of, for example, Si, and that has a small curvature. The first output-side high refractive index waveguide 62A is a waveguide that is formed on the first layer 70A, that is connected to the first output-side arm waveguide 24, that has a core made of, for example, Si, and that has a small curvature. The first low refractive index waveguide 63A is a straight waveguide that is formed on a second layer 70B on the Si substrate 71, that connects between the first input-side high refractive index waveguide 61A and the first output-side high refractive index waveguide 62A, and that has a core made of, for example, SiN. The second layer 70B is a high refractive index layer. Meanwhile, the first input-side high refractive index waveguide 61A and the first output-side high refractive index waveguide 62A are configured with Si waveguides, and therefore, can be folded shortly by being bent with a small curvature. The first folded waveguide 23 connects between the first input-side arm waveguide 22 and the first output-side arm waveguide 24. The first folded waveguide 23 includes the first input-side high refractive index waveguide 61A that is connected to the first input-side arm waveguide 22 and that serves as a first input-side folded waveguide that is located on the outer peripheral side of the folding, and the first output-side high refractive index waveguide 62A that is connected to the first output-side arm waveguide 24 and that serves as a first output-side folded waveguide that is located on the inner peripheral side of the folding.

The first input-side first-stage transition unit 64A1 includes an output end of the first input-side high refractive index waveguide 61A and an input end of the first low refractive index waveguide 63A, and allows transition of signal light between the first input-side high refractive index waveguide 61A and the first low refractive index waveguide 63A. The first output-side first-stage transition unit 64A2 includes an output end of the first low refractive index waveguide 63A and an input end of the first output-side high refractive index waveguide 62A, and allows transition of signal light between the first low refractive index waveguide 63A and the first output-side high refractive index waveguide 62A.

The second folded waveguide 33 includes a second input-side high refractive index waveguide 61B, a second output-side high refractive index waveguide 62B, a second low refractive index waveguide 63B, a second input-side first-stage transition unit 64B1, and a second output-side first-stage transition unit 64B2. The second input-side high refractive index waveguide 61B is a folded waveguide that is formed on the first layer 70A on the Si substrate 71, that is connected to the second input-side arm waveguide 32, that has a core made of, for example, Si, and that has a small curvature. The second output-side high refractive index waveguide 62B is a folded waveguide that is formed on the first layer 70A, that is connected to the second output-side arm waveguide 34, that has a core made of, for example, Si, and that has a small curvature. The second low refractive index waveguide 63B is a straight waveguide that is formed on the second layer 70B on the Si substrate 71, that connects between the second input-side high refractive index waveguide 61B and the second output-side high refractive index waveguide 62B, and that has a core made of, for example, SiN. Meanwhile, the second input-side high refractive index waveguide 61B and the second output-side high refractive index waveguide 62B are configured with Si waveguides, and therefore, can be folded shortly by being bent with a small curvature. The second folded waveguide 33 connects between the second input-side arm waveguide 32 and the second output-side arm waveguide 34. The second folded waveguide 33 includes the second input-side high refractive index waveguide 61B that is connected to the second input-side arm waveguide 32 and that serves as a second input-side folded waveguide that is located on the outer peripheral side of the folding, and the second output-side high refractive index waveguide 62B that is connected to the second output-side arm waveguide 34 and that serves as a second output-side folded waveguide that is located on the inner peripheral side of the folding.

The second input-side first-stage transition unit 64B1 includes an output end of the second input-side high refractive index waveguide 61B and an input end of the second low refractive index waveguide 63B, and allows transition of signal light between the second input-side high refractive index waveguide 61B and the second low refractive index waveguide 63B. The second output-side first-stage transition unit 64B2 includes an output end of the second low refractive index waveguide 63B and an input end of the second output-side high refractive index waveguide 62B, and allows transition of signal light between the second low refractive index waveguide 63B and the second output-side high refractive index waveguide 62B.

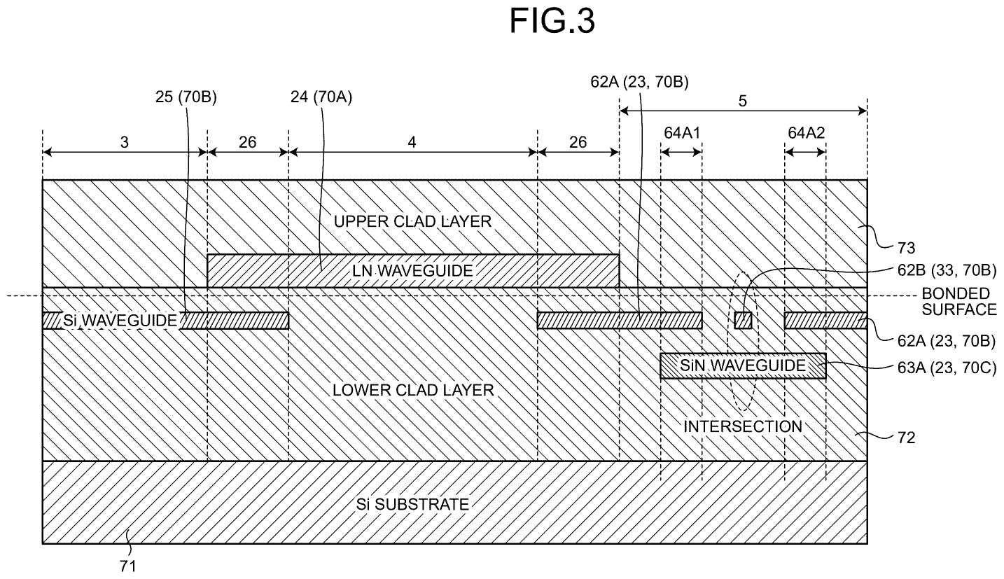

FIG. 3 is a schematic cross-sectional view illustrating an example of the optical modulator 1. The optical modulator 1 illustrated in FIG. 3 includes the Si substrate 71, a lower clad layer 72 that is laminated on the Si substrate 71, and an upper clad layer 73 that is laminated on the lower clad layer 72. The optical modulator 1 includes the first layer 70A, the second layer 70B, and a third layer 70C. The first layer 70A is a layer that is arranged between the upper clad layer 73 and the lower clad layer 72. The second layer 70B is a layer that is arranged at the near side of an upper clad layer 73B in the lower clad layer 72. The third layer 70C is a layer that is arranged at the near side of the Si substrate 71 in the lower clad layer 72. The first layer 70A serves as a core layer of the first output-side arm waveguide 24, for example. The second layer 70B serves as core layers of the first output waveguide 25, the first output-side high refractive index waveguide 62A, and the second output-side high refractive index waveguide 62B, for example. The second layer 70B is a high refractive index layer. The third layer 70C serves as a core layer of the first low refractive index waveguide 63A, for example. The third layer 70C is a first-stage refractive low index layer.

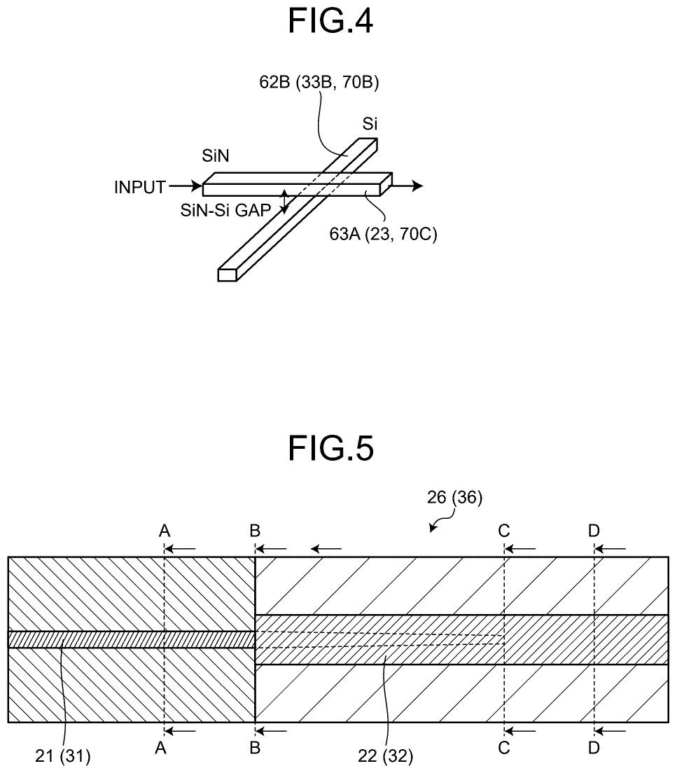

FIG. 4 is a perspective view illustrating an example of the first folded waveguide 23 and the second folded waveguide 33 at an intersection. At the intersection illustrated in FIG. 4, the first low refractive index waveguide 63A, which is arranged on the third layer 70C and included in the first folded waveguide 23, and the second output-side high refractive index waveguide 62B, which is arranged on the second layer 70B and included in the second folded waveguide 33, intersect with each other in a three-dimensional manner in different layers. As a result, the first folded waveguide 23 and the second folded waveguide 33 are low loss and able to prevent crosstalk between the first folded waveguide 23 and the second folded waveguide 33.

FIG. 5 is a schematic plan view illustrating a part of the first input-side modulation unit transition unit 26 or the second input-side modulation unit transition unit 36. Meanwhile, the first input-side modulation unit transition unit 26 or the second input-side modulation unit transition unit 36 is illustrated for the sake of simplicity of explanation. However, the first output-side modulation unit transition unit 27 and the second output-side modulation unit transition unit 37 have substantially the same structure; therefore, the same components and the same operation are denoted by the same reference symbols, and explanation of the same components and the same operation will be omitted. The first input-side modulation unit transition unit 26 illustrated in FIG. 5 includes an output end of the first input waveguide 21 and an input end of the first input-side arm waveguide 22. The first input waveguide 21 has a tapered structure in which a waveguide width is gradually reduced from the input end of the first input-side arm waveguide 22 toward an intermediate portion of the first input-side arm waveguide 22. Further, the second input-side modulation unit transition unit 36 includes the output end of the second input waveguide 31 and the input end of the second input-side arm waveguide 32. The second input waveguide 31 has a tapered structure in which a waveguide width is gradually reduced from the input end of the second input-side arm waveguide 32 toward an intermediate portion of the second input-side arm waveguide 32.

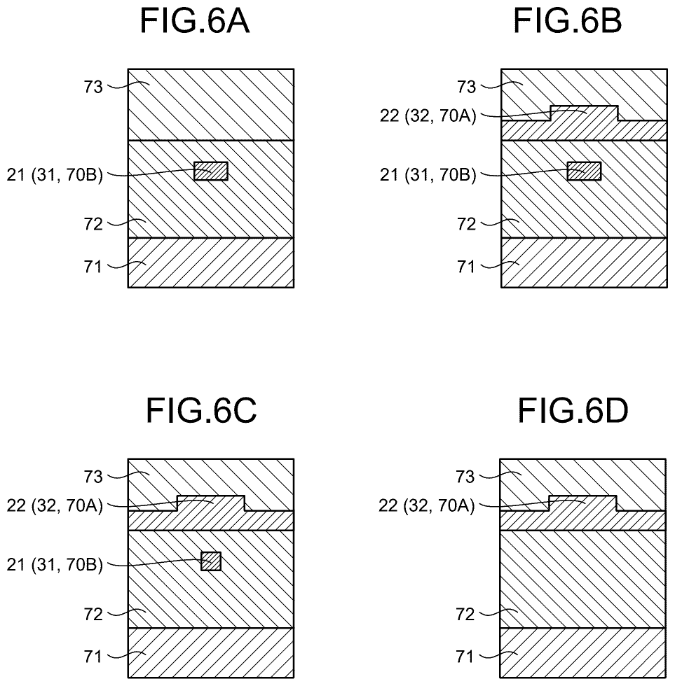

FIG. 6A is a schematic cross-sectional view illustrating an example of a cross-sectional portion taken along a line A-A illustrated in FIG. 5. A portion of the first input-side modulation unit transition unit 26 illustrated in FIG. 6A includes the Si substrate 71, the lower clad layer 72 that is laminated on the Si substrate 71, and the upper clad layer 73 that is laminated on the lower clad layer 72. The second layer 70B in the lower clad layer 72 is, for example, a layer that is made of Si and serves as a core layer of the first input waveguide 21. In other words, the first input waveguide 21 is an Si waveguide that has a channel structure.

FIG. 6B is a schematic cross-sectional view illustrating an example of a cross-sectional portion taken along a line B-B illustrated in FIG. 5. A portion of the first input-side modulation unit transition unit illustrated in FIG. 6B includes the Si substrate 71, the lower clad layer 72, and the upper clad layer 73. The second layer 70B in the lower clad layer 72 is the core layer of the first input waveguide 21, is a base of the tapered structure, and has a large width. The first layer 70A in the upper clad layer 73 serves as a core layer of the first input-side arm waveguide 22. Meanwhile, the first input-side arm waveguide 22 is, for example, a thin-film LN waveguide that has a rib structure.

FIG. 6C is a schematic cross-sectional view illustrating an example of a cross-sectional portion taken along a line C-C illustrated in FIG. 5. A portion of the input-side modulation unit transition unit illustrated in FIG. 6C includes the Si substrate 71, the lower clad layer 72, and the upper clad layer 73. The second layer 70B in the lower clad layer 72 is the core layer of the first input waveguide 21, is an end portion of the tapered structure, and has a smaller core width as compared to the portion illustrated in FIG. 6B. The first layer 70A in the upper clad layer 73 serves as the core layer of the first input-side arm waveguide 22.

FIG. 6D is a schematic cross-sectional view illustrating an example of a cross-sectional portion taken along a line D-D illustrated in FIG. 5. A portion of the first input-side modulation unit transition unit 26 illustrated in FIG. 6D includes the Si substrate 71, the lower clad layer 72, and the upper clad layer 73. In this portion, the second layer 70B is not present in the lower clad layer 72. The first layer 70A in the upper clad layer 73 serves as the core layer of the first input-side arm waveguide 22.

Meanwhile, the first input-side modulation unit transition unit 26 includes the output end of the first input-side arm waveguide 22 and an input end of the first input-side high refractive index waveguide 61A. The input end of the first input-side high refractive index waveguide 61A has a tapered structure in which a waveguide width is gradually reduced from the output end of the first input-side arm waveguide 22 toward the intermediate portion.

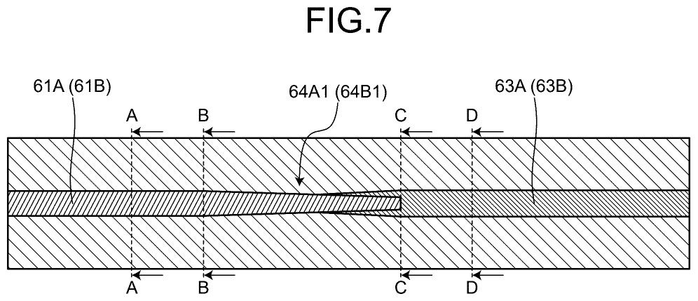

FIG. 7 is a schematic plan view illustrating an example of the first input-side first-stage transition unit 64A1. Meanwhile, the first input-side first-stage transition unit 64A1 in the first folded waveguide 23 is illustrated for the sake of simplicity of explanation. However, the second input-side first-stage transition unit 64B1 in the second folded waveguide 33 has the same structure; therefore, the same components and the same operation are denoted by the same reference symbols, and explanation of the same components and the same operation will be omitted. The first input-side first-stage transition unit 64A1 illustrated in FIG. 7 includes the output end of the first input-side high refractive index waveguide 61A and the input end of the first low refractive index waveguide 63A. The output end of the first input-side high refractive index waveguide 61A has a tapered structure in which a waveguide width is gradually reduced from the input end of the first low refractive index waveguide 63A toward an intermediate portion. The input end of the first low refractive index waveguide 63A has a tapered structure in which a waveguide width is gradually increased from the input end and the waveguide width remains constant in the intermediate portion. As a result, the waveguide width has the tapered structure, so that optical coupling between the first input-side high refractive index waveguide 61A and the first low refractive index waveguide 63A is made easier and it is possible to realize optical transition with low loss.

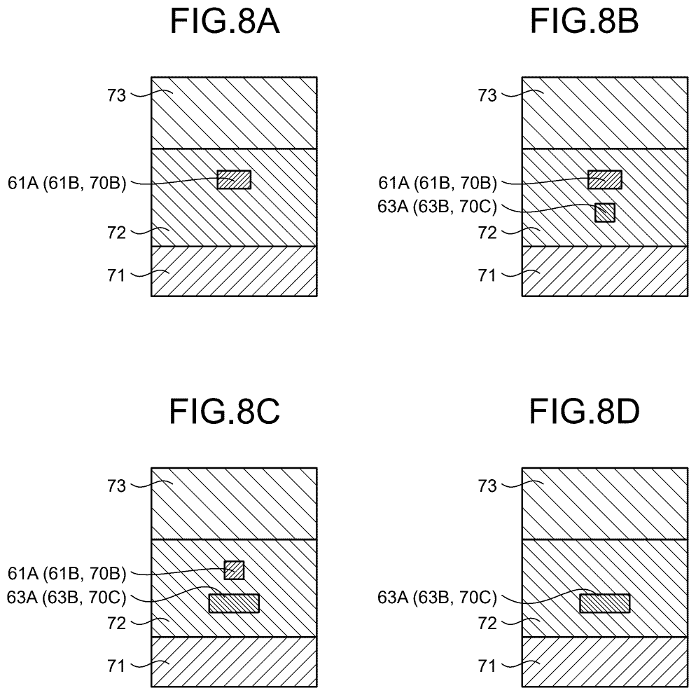

FIG. 8A is a schematic cross-sectional view illustrating an example of a cross-sectional portion taken along a line A-A illustrated in FIG. 7. The first folded waveguide 23 illustrated in FIG. 8A includes the Si substrate 71, the lower clad layer 72, and the upper clad layer 73. The second layer 70B in the lower clad layer 72 is, for example, a layer that is made of Si and serves as a core layer of the first input-side high refractive index waveguide 61A. In other words, the first input-side high refractive index waveguide 61A is an Si waveguide that has a channel structure.

FIG. 8B is a schematic cross-sectional view illustrating an example of a cross-sectional portion taken along a line B-B illustrated in FIG. 7. The first input-side first-stage transition unit 64A1 illustrated in FIG. 8B includes the Si substrate 71, the lower clad layer 72, and the upper clad layer 73. The second layer 70B in the lower clad layer 72 serves as the core layer of the first input-side high refractive index waveguide 61A. The third layer 70C in the lower clad layer 72 serves as a core layer of the first low refractive index waveguide 63A. In other words, the first low refractive index waveguide 63A is, for example, a SiN waveguide that has a channel structure. Here, a width of the first input-side high refractive index waveguide 61A is wide, and a width of the first low refractive index waveguide 63A is narrow.

FIG. 8C is a schematic cross-sectional view illustrating an example of a cross-sectional portion taken along a line C-C illustrated in FIG. 7. The first input-side first-stage transition unit 64A1 illustrated in FIG. 8C includes the Si substrate 71, the lower clad layer 72, and the upper clad layer 73. The second layer 70B in the lower clad layer 72 serves as the core layer of the first input-side high refractive index waveguide 61A. The third layer 70C in the lower clad layer 72 serves as a core layer of the first low refractive index waveguide 63A. Here, a width of the first input-side high refractive index waveguide 61A is narrow, and a width of the first low refractive index waveguide 63A is wide.

FIG. 8D is a schematic cross-sectional view illustrating an example of a cross-sectional portion taken along a line D-D illustrated in FIG. 7. The first folded waveguide 23 illustrated in FIG. 8D includes the Si substrate 71, the lower clad layer 72, and the upper clad layer 73. The third layer 70C in the lower clad layer 72 serves as the core layer of the first low refractive index waveguide 63A.

Meanwhile, the example is illustrated in which the first input-side first-stage transition unit 64A1 includes the output end of the first input-side high refractive index waveguide 61A and the input end of the first low refractive index waveguide 63A, but the first output-side first-stage transition unit 64A2 includes the output end of the first low refractive index waveguide 63A and the input end of the first output-side high refractive index waveguide 62A. In this case, the input end of the first output-side high refractive index waveguide 62A has a tapered structure in which a waveguide width is gradually reduced from the output end of the first low refractive index waveguide 63A toward the intermediate portion. The output end of the first low refractive index waveguide 63A has a tapered structure in which a waveguide width is gradually increased from the output end and the waveguide width remains constant in the intermediate portion.

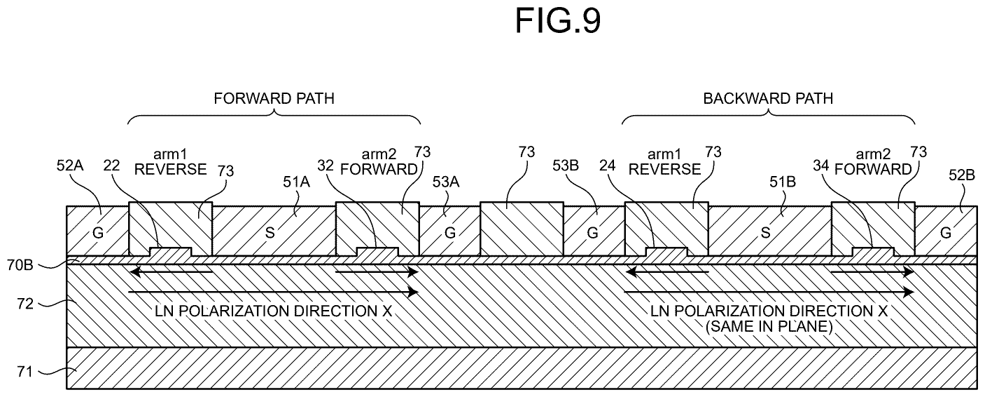

FIG. 9 is a schematic cross-sectional view illustrating an example of a cross-sectional portion taken along a line A-A illustrated in FIG. 1. The modulator main body 4 illustrated in FIG. 9 includes the Si substrate 71, the lower clad layer 72, the upper clad layer 73, and the electrode 50. The modulator main body 4 includes the first input-side arm waveguide 22 and the second input-side arm waveguide 32 for which the first layer 70A in the upper clad layer 73 serves as cores, and the first output-side arm waveguide 24 and the second output-side arm waveguide 34 for which the first layer 70A serves as cores. The electrode 50 that is arranged beside the upper clad layer 73 includes the input signal electrode 51A, the first input-side ground electrode 52A, the second input-side ground electrode 53A, the output signal electrode 51B, the first output-side ground electrode 52B, and the second output-side ground electrode 53B.

The input signal electrode 51A is arranged between the first input-side arm waveguide 22 and the second input-side arm waveguide 32. The first input-side ground electrode 52A is arranged so as to face the input signal electrode 51A across the first input-side arm waveguide 22. The second input-side ground electrode 53A is arranged on the opposite side of the input signal electrode 51A across the second input-side arm waveguide 32.

The output signal electrode 51B is arranged between the first output-side arm waveguide 24 and the second output-side arm waveguide 34. The first output-side ground electrode 52B is arranged so as to face the output signal electrode 51B across the first output-side arm waveguide 24. The second output-side ground electrode 53B is arranged on the opposite side of the output signal electrode 51B across the second output-side arm waveguide 34.

A polarization direction X of the modulator main body 4 is the same direction in a forward path and a backward path of the folding. The first input-side arm waveguide 22 modulates signal light, from the input signal electrode 51A to the first input-side ground electrode 52A, in accordance with an electrical signal in a reverse direction of the polarization direction X. The second input-side arm waveguide 32 modulates signal light, from the input signal electrode 51A to the second input-side ground electrode 53A, in accordance with an electrical signal in a forward direction of the polarization direction X.

In contrast, the first output-side arm waveguide 24 modulates signal light, from the output signal electrode 51B to the first output-side ground electrode 52B, in accordance with an electrical signal in the reverse direction of the polarization direction X. The second output-side arm waveguide 34 modulates signal light, from the output signal electrode 51B to the second output-side ground electrode 53B, in accordance with an electrical signal in the forward direction of the polarization direction X.

In other words, the first input-side arm waveguide 22 and the first output-side arm waveguide 24 modulate the signal light in accordance with the electrical signal in the same reverse direction. The second input-side arm waveguide 32 and the second output-side arm waveguide 34 modulate the signal light in accordance with the electrical signal in the same forward direction. The electrical signal in the same direction is applied in the input-side forward path and the output-side backward path, so that it is possible to improve modulation efficiency. Furthermore, the second input-side arm waveguide 32 and the second output-side arm waveguide 34 is able to realize push-pull operation in which a phase changes in an opposite direction as compared to the first input-side arm waveguide 22 and the first output-side arm waveguide 24.

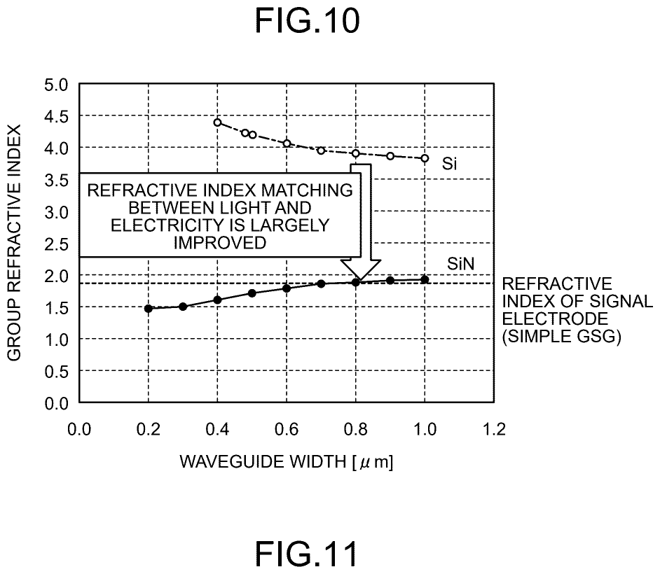

FIG. 10 is a diagram for explaining an example of a relationship between a refractive index and a waveguide width in an Si waveguide, a SiN waveguide, and a signal electrode. The first folded waveguide 23 includes the first input-side high refractive index waveguide 61A, the first output-side high refractive index waveguide 62A, and the first low refractive index waveguide 63A. The first input-side high refractive index waveguide 61A and the first output-side high refractive index waveguide 62A are, for example, Si waveguides. The first low refractive index waveguide 63A is, for example, a SiN waveguide. As illustrated in FIG. 10, the refractive index of the SiN waveguide is 1.6 to 1.9, which is close to the refractive index of the electrical signal; therefore, a part of the first folded waveguide 23 is configured with the SiN waveguide. As a result, it is possible to approximately achieve velocity matching even when an electrical wiring length of the folded signal electrode 51C is approximately the same as the waveguide length, so that it is possible to omit or reduce a delay electrode for the velocity matching. Meanwhile, explanation has been given of the first folded waveguide 23, but the same effect is achieved with respect to the second folded waveguide 33.

FIG. 11 is a diagram for explaining an example of a comparison result of an optical path length and an electrode length of the folded portion 5 among the first embodiment, a first comparative example, and a second comparative example. The first folded waveguide 23 includes the first input-side high refractive index waveguide 61A, the first output-side high refractive index waveguide 62A, and the first low refractive index waveguide 63A. The first input-side high refractive index waveguide 61A is an Si bent waveguide that includes a bent portion R and portions ahead and behind the bent portion R. The first output-side high refractive index waveguide 62A is an Si bent waveguide that includes the bent portion R and portions ahead and behind the bent portion R. The first low refractive index waveguide 63A is a SiN straight waveguide that includes a straight portion.

Furthermore, as the first comparative example, a first folded waveguide includes an input-side waveguide, an output-side waveguide, and a straight waveguide that connects between the input-side waveguide and the output-side waveguide, and is configured with an Si waveguide. Meanwhile, for the sake of simplicity of explanation, it is assumed that the first folded waveguide of the first comparative example has the same configuration as the first folded waveguide 23 of the first embodiment, but is different in that the first folded waveguide of the first comparative example is configured with the Si waveguide. The input-side waveguide is an Si bent waveguide that includes a bent portion and portions ahead and behind the bent portion. The output-side waveguide is an Si bent waveguide that includes a bent portion and portions ahead and behind the bent portion. The straight waveguide is an Si straight waveguide that includes a straight portion.

Moreover, as the second comparative example, a first folded waveguide includes an input-side waveguide, an output-side waveguide, and a straight waveguide that connects between the input-side waveguide and the output-side waveguide, and is configured with a SiN waveguide. Meanwhile, for the sake of simplicity of explanation, it is assumed that the first folded waveguide of the second comparative example has the same configuration as the first folded waveguide 23 of the first embodiment, but is different in that the first folded waveguide of the second comparative example is configured with the SiN waveguide. The input-side waveguide is a SiN bent waveguide that includes a bent portion and portions ahead and behind the bent portion. The output-side waveguide is a SiN bent waveguide that includes a bent portion and portions ahead and behind the bent portion. The straight waveguide is a SiN straight waveguide that includes a straight portion.

First, in the first folded waveguide of the first comparative example, when a waveguide length L of the portions ahead and behind the bent portion of the input-side waveguide is set to 20 micrometers (μm), an optical path length of the portions ahead and behind the bent portion of the input-side waveguide is 80 μm because the refractive index of the Si waveguide is about 4. An optical path length of the portions ahead and behind the bent portion of the output-side waveguide is also 80 μm. In the case of the Si waveguide, it is possible to realize a low-loss bent waveguide even with a small curvature radius, and therefore, it is possible to reduce a curvature radius of the bent portion of the input-side waveguide to, for example, 10 μm. The refractive index of the Si waveguide is about 4, so that an optical path length of the bent portion is 63 μm. An optical path length of the bent portion of the output-side waveguide is also 63 μm. Furthermore, when a waveguide length of the straight portion is set to 400 μm, an optical path length of the straight portion is 1600 because the refractive index of the Si waveguide is about 4. As a result, a total optical path length of the first folded waveguide is 1743. To achieve velocity matching between light and an electrical signal, it is needed to match a product of the refractive index and the length (n×L) between the optical waveguide and the electrical wiring. In the configuration of the first comparative example, the refractive index of the electrical signal is about 1.9; therefore, it is sufficient to set the electrical wiring length to 917 μm to achieve velocity matching, and, when the first folded waveguide is configured with only the Si waveguide, the refractive index of the first folded waveguide is increased and an optical path length of light is increased, so that the electrical wiring length needs to be increased by a ratio of the refractive indices to realize velocity matching and is set to about 0.9 millimeters (mm).

In the second comparative example, when a waveguide length L of the portions ahead and behind the bent portion of the input-side waveguide is set to 20 μm, an optical path length the portions ahead and behind the bent portion of the input-side waveguide is 38 μm because the refractive index of the SiN waveguide is 1.9. An optical path length of the portions ahead and behind the bent portion of the output-side waveguide is also 38 μm. In the SiN waveguide, the refractive index of the core is relatively low; therefore, it is needed to increase a curvature radius to bend the waveguide with low loss, so that the curvature radius of the bent portion of the input-side waveguide needs to be set to 60 μm or more, for example. The refractive index of the SiN waveguide is 1.9, so that an optical path length of the bent portion is 179 μm. An optical path length of the bent portion of the output-side waveguide is also 179 μm. Furthermore, when a waveguide length of the straight portion is set to 400 μm, an optical path length of the straight portion is 760 because the refractive index of the SiN waveguide is 1.9. As a result, an optical path length of the first folded waveguide is 977. Similarly to the first comparative example, to achieve velocity matching between light and an electrical signal, it is needed to match a product of the refractive index and the length (n×L) between the optical waveguide and the electrical wiring. In the configuration of the second comparative example, the refractive index of the electrical signal is about 1.9; therefore, it is sufficient to set the electrical wiring length to 514 μm to achieve velocity matching. When the first folded waveguide is configured with only the SiN waveguide, the refractive index of the first folded waveguide is reduced, but it is needed to enhance curvatures of the bent waveguide from 10 μm to 60 μm as compared to the Si waveguide. As a result, an actual length of the waveguide is increased, so that the electrical wiring length is accordingly increased to about 515 μm.

In contrast, in the first folded waveguide 23 of the first embodiment, when a waveguide length L of the portions ahead and behind the bent portion R of the first input-side high refractive index waveguide 61A is set to 20 μm, an optical path length of the portions ahead and behind the bent portion R of the first input-side high refractive index waveguide 61A is 80 μm because the refractive index of the Si waveguide is 4. An optical path length of the portions ahead and behind the bent portion R of the first output-side high refractive index waveguide 62A is also 80 μm. A curvature radius of the bent portion R of the first input-side high refractive index waveguide 61A can be reduced to 10 μm in the Si waveguide, and an optical path length of the bent portion R is 63 μm because the refractive index of the Si waveguide is about 4. An optical path length of the bent portion R of the first output-side high refractive index waveguide 62A is also 63 μm. In contrast, a waveguide of the straight portion is a SiN waveguide with a low refractive index, and the refractive index is 1.9, which is low. Therefore, when a waveguide length is set to 400 μm, an optical path length of the straight portion is 760. As a result, a total optical path length of the first folded waveguide 23 is 903. Similarly to the first comparative example and the second comparative example, to achieve velocity matching between light and an electrical signal, it is needed to match a product of the refractive index and the length (n×L) between the optical waveguide and the electrical wiring. In the configuration of the first embodiment, the refractive index of the electrical signal is about 1.9; therefore, it is sufficient to set the electrical wiring length to 475 μm to achieve velocity matching. In the present embodiment, the bent waveguide portions of the first input-side high refractive index waveguide 61A and the first output-side high refractive index waveguide 62A are configured with Si waveguides to reduce actual lengths, and the liner portion in which a long waveguide is drawn is configured with a SiN waveguide as the first low refractive index waveguide 63A. As a result, due to the effect of reduction of the optical path length by reduction of the actual lengths using the Si waveguides and reduction of the refractive index of the SiN waveguide, it is possible to reduce the electrode length to 475 μm, so that it is possible to reduce the electrode length and reduce the chip size.

An electrode length of the folded signal electrode 51C of the first embodiment is 475 μm, an electrode length of the folded signal electrode of the first comparative example is 917 μm, and an electrode length of the folded signal electrode of the second comparative example is 514 μm. Therefore, the electrode length of the folded signal electrode 51C of the first embodiment is reduced, so that it is possible to reduce the chip size of the optical modulator 1 as compared to the electrode lengths of the first comparative example and the second comparative example.

The first input-side high refractive index waveguide 61A and the first output-side high refractive index waveguide 62A of the first folded waveguide 23 of the first embodiment are configured with the Si waveguides in which curvature can be reduced, and the first low refractive index waveguide 63A subsequent to the bend is configured with the SiN waveguide that is advantageous to the velocity matching. It is possible to reduce the lengths of the Si waveguide portions of the first input-side high refractive index waveguide 61A and the first output-side high refractive index waveguide 62A, increase the length of the SiN waveguide portion of the first low refractive index waveguide 63A, reduce the total length of the waveguide, and reduce the optical path length. As a result, it is possible to reduce the electrode length of the folded signal electrode 51C that needs to match with the optical path length of the first folded waveguide 23, so that it is possible to reduce a length of a delay waveguide, which leads to reduction of a size of the folded portion.

The second input-side high refractive index waveguide 61B and the second output-side high refractive index waveguide 62B of the second folded waveguide 33 are configured with the Si waveguides in which curvature can be reduced, and the second low refractive index waveguide 63B subsequent to the bend is configured with the SiN waveguide that is advantageous to the velocity matching. It is possible to reduce the lengths of the Si waveguide portions of the second input-side high refractive index waveguide 61B and the second output-side high refractive index waveguide 62B, increase the length of the SiN waveguide portion of the second low refractive index waveguide 63B, reduce the total length of the waveguide, and reduce the optical path length. As a result, it is possible to reduce the electrode length of the folded signal electrode 51C that needs to match with the optical path length of the second folded waveguide 33, so that it is possible to reduce the length of the delay waveguide, which leads to reduction of the size of the folded portion. In other words, it is possible to ensure the velocity matching and reduce the chip size of the optical modulator 1.

Meanwhile, the lengths of the Si waveguide and the SiN waveguide are appropriately adjusted by left and right arms such that the optical path lengths of the first folded waveguide 23 and the second folded waveguide 33 are equalized. For example, a method of equalizing the lengths of the Si waveguides or the lengths of the SiN waveguides is known, but the method is not specifically limited as long as the optical path lengths are equalized.

In the optical modulator 1 of the first embodiment, the LN waveguide is described as an example of the waveguide that is made of a high EO material, but embodiments are not limited to this example, and it is possible to achieve the same effects by a waveguide that is made of a high EO material, such as BaTiO₃, PLZT, or PZT, with the Pockels coefficient of 10 μm/V or more.

Meanwhile, for the sake of simplicity of explanation, the Si waveguide is described as an example of the high refractive index waveguide and the SiN waveguide is described as an example of the low refractive index waveguide, but embodiments are not limited to this example, and appropriate modifications may be made.

In the first folded waveguide 23 and the second folded waveguide 33 of the first embodiment, the case has been described in which the first output-side high refractive index waveguide 62A and the first low refractive index waveguide 63A intersect with each other in a three-dimensional manner. However, embodiments are not limited to this example, and a different embodiment will be described below as a second embodiment. Meanwhile, the same components as those of the optical modulator 1 of the first embodiment are denoted by the same reference symbols, and explanation of the same components and the same operation will be omitted.

### (b) Second Embodiment

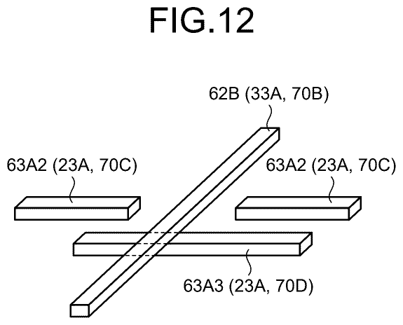

FIG. 12 is a perspective view illustrating an example of a first folded waveguide 23A and a second folded waveguide 33A of an optical modulator 1A of the second embodiment. The optical modulator 1 of the first embodiment and the optical modulator 1A of the second embodiment are different from each other in that the first folded waveguide 23A and the second folded waveguide 33A are configured to cause signal light to transition by using three-layer different waveguides, and a distance between a high refractive index waveguide and a low refractive index waveguide at an intersection of the waveguides is increased.

The first folded waveguide 23A includes the first input-side high refractive index waveguide 61A, the first output-side high refractive index waveguide 62A, a first input-side first-stage refractive index waveguide 63A1, a first output-side first-stage refractive index waveguide 63A2, and a first second-stage low refractive index waveguide 63A3. The first folded waveguide 23A includes a first input-side first-stage transition unit 64A11, a first input-side second-stage transition unit 64A31, a first output-side second-stage transition unit 64A41, and a first output-side first-stage transition unit 64A21. The first input-side high refractive index waveguide 61A is, for example, an Si waveguide that adopts the second layer 70B of the lower clad layer 72 as a core layer and that is connected to the output end of the first input-side arm waveguide 22. The first output-side high refractive index waveguide 62A is, for example, an Si waveguide that adopts the second layer 70B as a core layer and that is connected to the input end of the first output-side arm waveguide 24.

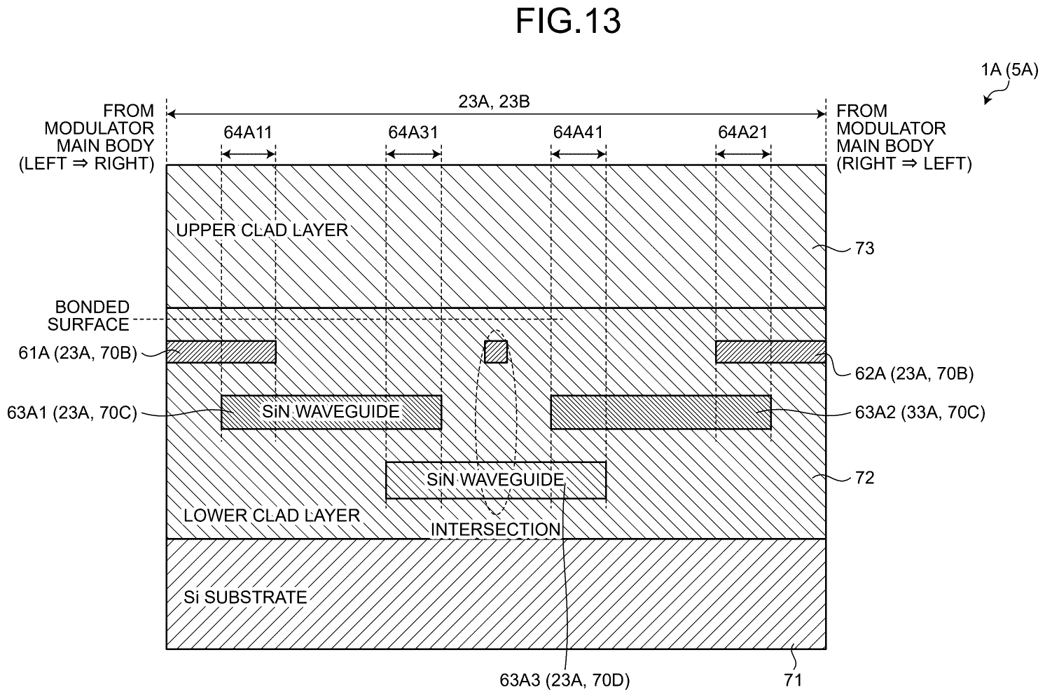

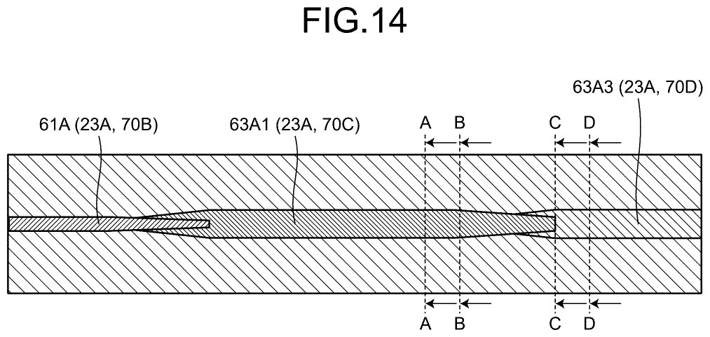

FIG. 13 is a schematic cross-sectional view illustrating an example of a folded portion 5A of the optical modulator 1A of the second embodiment. The first input-side first-stage refractive index waveguide 63A1 is, for example, a SiN waveguide that adopts the third layer 70C of the lower clad layer 72 as a core layer and that is indirectly connected to the output end of the first input-side high refractive index waveguide 61A. The first output-side first-stage refractive index waveguide 63A2 is, for example, a SiN waveguide that adopts the third layer 70C as a core layer and that is indirectly connected to the input end of the first output-side high refractive index waveguide 62A.

The first second-stage low refractive index waveguide 63A3 is, for example, a SiN waveguide that adopts a fourth layer 70D of the lower clad layer 72 as a core layer and that indirectly connects the first input-side first-stage refractive index waveguide 63A1 and the first output-side first-stage refractive index waveguide 63A2. The fourth layer 70D is a second-stage low refractive index layer.

The first input-side first-stage transition unit 64A11 includes the output end of the first input-side high refractive index waveguide 61A and an input end of the first input-side first-stage refractive index waveguide 63A1, and allows transition of signal light between the first input-side high refractive index waveguide 61A and the first input-side first-stage refractive index waveguide 63A1. The first output-side first-stage transition unit 64A21 includes an output end of the first output-side first-stage refractive index waveguide 63A2 and the input end of the first output-side high refractive index waveguide 62A, and allows transition of signal light between the first output-side first-stage refractive index waveguide 63A2 and the first output-side high refractive index waveguide 62A.

The first input-side second-stage transition unit 64A31 includes an output end of the first input-side first-stage refractive index waveguide 63A1 and an input end of the first second-stage low refractive index waveguide 63A3, and allows transition of signal light between the first input-side first-stage refractive index waveguide 63A1 and the first second-stage low refractive index waveguide 63A3. The first output-side second-stage transition unit 64A41 includes an output end of the first second-stage low refractive index waveguide 63A3 and an input end of the first output-side first-stage refractive index waveguide 63A2, and allows transition of signal light between the first second-stage low refractive index waveguide 63A3 and the first output-side first-stage refractive index waveguide 63A2.

The second folded waveguide 33A includes the second input-side high refractive index waveguide 61B, the second output-side high refractive index waveguide 62B, a second input-side first-stage low refractive index waveguide 63B1, a second output-side first-stage low refractive index waveguide 63B2, and a second second-stage low refractive index waveguide 63B3. The second folded waveguide 33A includes a second input-side first-stage transition unit 64B11, a second input-side second-stage transition unit 64B31, a second output-side second-stage transition unit 64B41, and a second output-side first-stage transition unit 64B21. The second input-side high refractive index waveguide 61B is, for example, an Si waveguide that adopts the second layer 70B of the lower clad layer 72 as a core layer and that is connected to the output end of the second input-side arm waveguide 32. The second output-side high refractive index waveguide 62B is, for example, an Si waveguide that adopts the second layer 70B as a core layer and that is connected to the input end of the second output-side arm waveguide 34.

The second input-side first-stage low refractive index waveguide 63B1 is, for example, a SiN waveguide that adopts the third layer 70C of the lower clad layer 72 as a core layer and that is indirectly connected to the output end of the second input-side high refractive index waveguide 61B. The second output-side first-stage low refractive index waveguide 63B2 is, for example, a SiN waveguide that adopts the third layer 70C as a core layer and that is indirectly connected to the input end of the second output-side high refractive index waveguide 62B.

The second second-stage low refractive index waveguide 63B3 is, for example, a SiN waveguide that adopts the fourth layer 70D of the lower clad layer 72 as a core layer and that indirectly connects the second input-side first-stage low refractive index waveguide 63B1 and the second output-side first-stage low refractive index waveguide 63B2.

The second input-side first-stage transition unit 64B11 includes the output end of the second input-side high refractive index waveguide 61B and an input end of the second input-side first-stage low refractive index waveguide 63B1, and allows transition of signal light between the second input-side high refractive index waveguide 61B and the second input-side first-stage low refractive index waveguide 63B1. The second output-side first-stage transition unit 64B21 includes an output end of the second output-side first-stage low refractive index waveguide 63B2 and the input end of the second output-side high refractive index waveguide 62B, and allows transition of signal light between the second output-side first-stage low refractive index waveguide 63B2 and the second output-side high refractive index waveguide 62B.

The second input-side second-stage transition unit 64B31 includes the input end of the second input-side first-stage low refractive index waveguide 63B1 and the second second-stage low refractive index waveguide 63B3, and allows transition of signal light between the second input-side first-stage low refractive index waveguide 63B1 and the second second-stage low refractive index waveguide 63B3. The second output-side second-stage transition unit 64B41 includes an output end of the second second-stage low refractive index waveguide 63B3 and an input end of the second output-side first-stage low refractive index waveguide 63B2, and allows transition of signal light between the second second-stage low refractive index waveguide 63B3 and the second output-side first-stage low refractive index waveguide 63B2.

As illustrated in FIG. 13, the first output-side arm waveguide 24 is connected to the first output-side high refractive index waveguide 62A across the second second-stage low refractive index waveguide 63B3. As a result, as compared to the optical modulator 1 of the first embodiment, a distance between the second second-stage low refractive index waveguide 63B3 and the first output-side high refractive index waveguide 62A is increased, so that it is possible to prevent loss and crosstalk at the intersection.

FIG. 14 is a schematic plan view illustrating an example of the first input-side first-stage transition unit 64A11 and the first input-side second-stage transition unit 64A31 in the first folded waveguide 23A. Meanwhile, for the sake of simplicity of explanation, the first input-side first-stage transition unit 64A11 and the first input-side second-stage transition unit 64A31 in the first folded waveguide 23A are illustrated by way of example. However, the second input-side first-stage transition unit 64B11 and the second input-side second-stage transition unit 64B31 in the second folded waveguide 33A have the same configurations; therefore, the same components and the same operation are denoted by the same reference symbols, and explanation of the same components and the same operation will be omitted. The first folded waveguide 23A illustrated in FIG. 14 includes the first input-side high refractive index waveguide 61A, the first input-side first-stage refractive index waveguide 63A1, and the first second-stage low refractive index waveguide 63A3. The output end of the first input-side high refractive index waveguide 61A has a tapered structure in which a waveguide width is gradually reduced from the input end of the first input-side first-stage refractive index waveguide 63A1 toward an intermediate portion. The input end of the first input-side first-stage refractive index waveguide 63A1 has a tapered structure in which a waveguide width is gradually increased from the input end and the waveguide width remains constant in the intermediate portion. The output end of the first input-side first-stage refractive index waveguide 63A1 has a tapered structure in which a waveguide width is gradually increased from the output end and the waveguide width remains constant in the intermediate portion. An input end of the first second-stage low refractive index waveguide 63A3 has a tapered structure in which a waveguide width is gradually increased from the input end and the waveguide width remains constant in the intermediate portion. As a result, the waveguide width has the tapered structure, so that optical coupling between the first input-side first-stage refractive index waveguide 63A1 and the first second-stage low refractive index waveguide 63A3 and it is possible to realize optical transition with low loss.

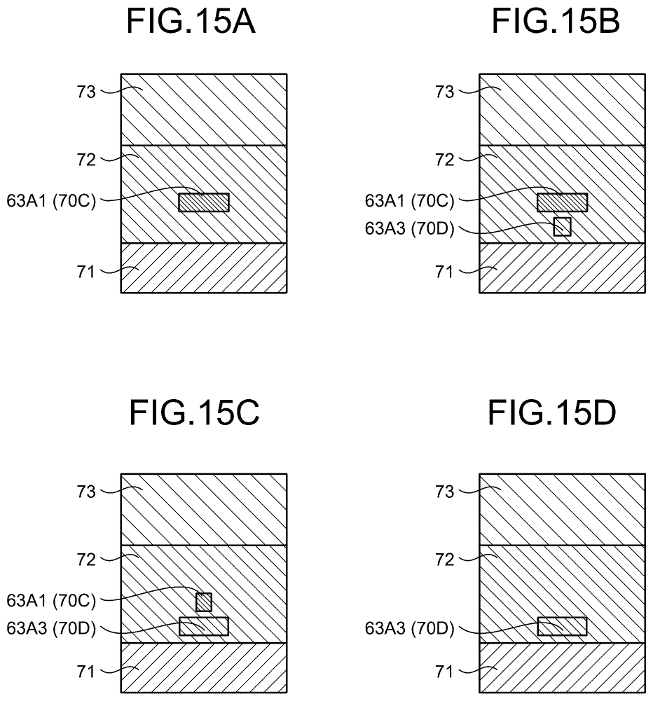

FIG. 15A to FIG. 15D are schematic cross-sectional view illustrating cross-sectional structures at a plurality of positions in the first input-side second-stage transition unit 64A31. FIG. 15A is a schematic cross-sectional view illustrating an example of a cross-sectional portion taken along a line A-A illustrated in FIG. 14. A portion of the first folded waveguide 23A illustrated in FIG. 15A includes the Si substrate 71, the lower clad layer 72, and the upper clad layer 73. The third layer 70C in the lower clad layer 72 is, for example, SiN and serves as a core layer of the first input-side first-stage refractive index waveguide 63A1. In other words, the first input-side first-stage refractive index waveguide 63A1 is a SiN waveguide that has a channel structure.

FIG. 15B is a schematic cross-sectional view illustrating an example of a cross-sectional portion taken along a line B-B illustrated in FIG. 14. The first input-side second-stage transition unit 64A31 in the first folded waveguide 23A illustrated in FIG. 15B includes the Si substrate 71, the lower clad layer 72, and the upper clad layer 73. The third layer 70C of the lower clad layer 72 is, for example, SiN and serves as a core layer of the first input-side first-stage refractive index waveguide 63A1. The fourth layer 70D of the lower clad layer 72 is, for example, SiN and serves as a core layer of the first second-stage low refractive index waveguide 63A3. In other words, the first second-stage low refractive index waveguide 63A3 is a SiN waveguide that has a channel structure. In this portion, a width of the first input-side first-stage refractive index waveguide 63A1 is increased, and a width of the first second-stage low refractive index waveguide 63A3 is reduced.

FIG. 15C is a schematic cross-sectional view illustrating an example of a cross-sectional portion taken along a line C-C illustrated in FIG. 14. The first input-side second-stage transition unit 64A31 in the first folded waveguide 23A illustrated in FIG. 15C includes the Si substrate 71, the lower clad layer 72, and the upper clad layer 73. The third layer 70C of the lower clad layer 72 is, for example, SiN and serves as a core layer of the first input-side first-stage refractive index waveguide 63A1. The fourth layer 70D of the lower clad layer 72 is, for example, SiN and serves as a core layer of the first second-stage low refractive index waveguide 63A3.

FIG. 15D is a schematic cross-sectional view illustrating an example of a cross-sectional portion taken along a line D-D illustrated in FIG. 14. A portion of the first folded waveguide 23A illustrated in FIG. 15D includes the Si substrate 71, the lower clad layer 72, and the upper clad layer 73. The fourth layer 70D of the lower clad layer 72 is SiN and serves as a core layer of the first second-stage low refractive index waveguide 63A3.

The input end of the first output-side high refractive index waveguide 62A has a tapered structure in which a waveguide width is gradually reduced from the output end of the first output-side first-stage refractive index waveguide 63A2 toward an intermediate portion. The input end of the first output-side first-stage refractive index waveguide 63A2 has a tapered structure in which a waveguide width is gradually increased from the input end and the waveguide width remains constant in the intermediate portion. The output end of the first output-side first-stage refractive index waveguide 63A2 has a tapered structure in which a waveguide width is gradually increased from the output end and the waveguide width remains constant with approach to the intermediate portion. The input end of the first second-stage low refractive index waveguide 63A3 has a tapered structure in which a waveguide width is gradually increased from the input end and the waveguide width remains constant in the intermediate portion.

The first input-side high refractive index waveguide 61A and the first output-side high refractive index waveguide 62A of the first folded waveguide 23A of the second embodiment are configured with the Si waveguides in which curvature can be reduced. Further, the first input-side first-stage refractive index waveguide 63A1, the first second-stage low refractive index waveguide 63A3, and the first output-side first-stage refractive index waveguide 63A2 subsequent to the bend are configured with the SiN waveguides that are advantageous to the velocity matching. The lengths of the Si waveguide portions of the first input-side high refractive index waveguide 61A and the first output-side high refractive index waveguide 62A are reduced, and the lengths of the SiN waveguide portions of the first input-side first-stage refractive index waveguide 63A1, the first second-stage low refractive index waveguide 63A3, and the first output-side first-stage refractive index waveguide 63A2 are increased. Therefore, it is possible to reduce the total length of the waveguide and reduce the optical path length. As a result, it is possible to reduce the electrode length of the folded signal electrode 51C that needs to match with the optical path length of the first folded waveguide 23A, so that it is possible to reduce the length of the delay waveguide, which leads to reduction of the size of the folded portion.

The second input-side high refractive index waveguide 61B and the second output-side high refractive index waveguide 62B of the second folded waveguide 33A are configured with the Si waveguides in which curvature can be reduced. Further, the second input-side first-stage low refractive index waveguide 63B1, the second second-stage low refractive index waveguide 63B3, and the second output-side first-stage low refractive index waveguide 63B2 subsequent to the bend are configured with the SiN waveguides that are advantageous to the velocity matching. The lengths of the Si waveguide portions of the second input-side high refractive index waveguide 61B and the second output-side high refractive index waveguide 62B are reduced, and the lengths of the SiN waveguide portions of the second input-side first-stage low refractive index waveguide 63B1, the second second-stage low refractive index waveguide 63B3, and the second output-side first-stage low refractive index waveguide 63B2 are increased. Therefore, it is possible to reduce the total length of the waveguide and reduce the optical path length. As a result, it is possible to reduce the electrode length of the folded signal electrode 51C that needs to match with the optical path length of the second folded waveguide 33A, so that it is possible to reduce the length of the delay waveguide, which leads to reduction of the size of the folded portion. In other words, it is possible to ensure the velocity matching and reduce a chip size of the optical modulator 1A.

Meanwhile, in the optical modulator 1 of the first embodiment, the first input-side arm waveguide 22 is arranged on the outer peripheral side, the first output-side arm waveguide 24 is arranged on the inner peripheral side, the second input-side arm waveguide 32 is arranged on the inner peripheral side, and the second output-side arm waveguide 34 is arranged on the outer peripheral side. Therefore, in the optical modulator 1, the example has been described in which the interception is made by the first folded waveguide 23 and the second folded waveguide 33 intersect. However, embodiments are not limited to this example, and it may be possible to arrange the first input-side arm waveguide 22 on the outer peripheral side, the first output-side arm waveguide 24 on the outer peripheral side, the second input-side arm waveguide 32 on the inner peripheral side, and the second output-side arm waveguide 34 on the inner peripheral side. This embodiment will be described below as a third embodiment.

### (c) Third Embodiment

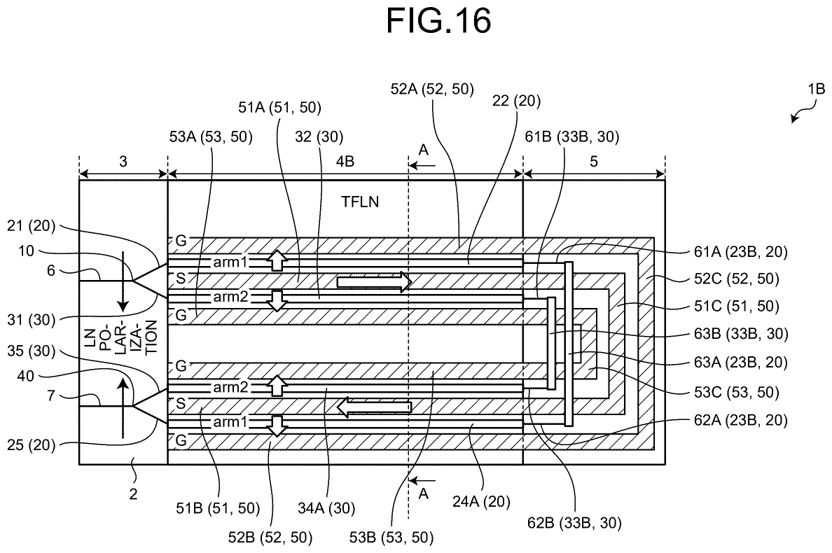

FIG. 16 is a schematic plan view illustrating an example of an optical modulator 1B of a third embodiment. Meanwhile, the same components as those of the optical modulator 1 of the first embodiment are denoted by the same reference symbols, and explanation of the same components and the same operation will be omitted. The optical modulator 1 of the first embodiment and the optical modulator 1B of the third embodiment are different from each other in that there is no intersection between a first folded waveguide 23B and a second folded waveguide 33B, and the polarization direction X is reversed between the first and second input-side arm waveguides 22, 32 and the first and second output-side arm waveguides 24, 34.

The first waveguide 20 includes the first input-side arm waveguide 22 that is located on an outer peripheral side of the folding, the first folded waveguide 23B that is located on the outer peripheral side, and the first output-side arm waveguide 24A that is located on the outer peripheral side. The second waveguide 30 includes the second input-side arm waveguide 32 that is located on the inner peripheral side, the second folded waveguide 33B that is located on the inner peripheral side, and a second output-side arm waveguide 34A that is located on the inner peripheral side.

The first folded waveguide 23B includes the first input-side high refractive index waveguide 61A, the first output-side high refractive index waveguide 62A, the first low refractive index waveguide 63A, the first input-side first-stage transition unit 64A1, and the first output-side first-stage transition unit 64A2. The first input-side high refractive index waveguide 61A is, for example, an Si waveguide that is formed on the first layer 70A on the Si substrate 71 and connected to the first input-side arm waveguide 22 that is located on the outer peripheral side. The first output-side high refractive index waveguide 62A is, for example, an Si waveguide that is formed on the first layer 70A and connected to the first output-side arm waveguide 24A that is located on the outer peripheral side. The first low refractive index waveguide 63A is, for example, a SiN waveguide that is formed on the second layer 70B on the Si substrate 71 and that connects between the first input-side high refractive index waveguide 61A and the first output-side high refractive index waveguide 62A.

The first input-side first-stage transition unit 64A1 includes the output end of the first input-side high refractive index waveguide 61A and the input end of the first low refractive index waveguide 63A, and allows transition of signal light between the first input-side high refractive index waveguide 61A and the first low refractive index waveguide 63A. The first output-side first-stage transition unit 64A2 includes the output end of the first low refractive index waveguide 63A and the input end of the first output-side high refractive index waveguide 62A, and allows transition of signal light between the first low refractive index waveguide 63A and the first output-side high refractive index waveguide 62A.

The second folded waveguide 33B includes the second input-side high refractive index waveguide 61B, the second output-side high refractive index waveguide 62B, the second low refractive index waveguide 63B, the second input-side first-stage transition unit 64B1, and the second output-side first-stage transition unit 64B2. The second input-side high refractive index waveguide 61B is, for example, an Si waveguide that is formed on the first layer 70A on the Si substrate 71 and connected to the second input-side arm waveguide 32 that is located on the inner peripheral side. The second output-side high refractive index waveguide 62B is, for example, an Si waveguide that is formed on the first layer 70A and connected to the second output-side arm waveguide 34A that is located on the inner peripheral side. The second low refractive index waveguide 63B is, for example, a SiN waveguide that is formed on the second layer 70B on the Si substrate 71 and that connects between the second input-side high refractive index waveguide 61B and the second output-side high refractive index waveguide 62B.

The second input-side first-stage transition unit 64B1 includes the output end of the second input-side high refractive index waveguide 61B and the input end of the second low refractive index waveguide 63B, and allows transition of signal light between the second input-side high refractive index waveguide 61B and the second low refractive index waveguide 63B. The second output-side first-stage transition unit 64B2 includes the output end of the second low refractive index waveguide 63B and the input end of the second output-side high refractive index waveguide 62B, and allows transition of signal light between the second low refractive index waveguide 63B and the second output-side high refractive index waveguide 62B.

The electrode 50 is an electrode that has a GSG structure and that includes the signal electrode 51, the first ground electrode 52, and the second ground electrode 53. The signal electrode 51 includes the input signal electrode 51A, the output signal electrode 51B, and the folded signal electrode 51C. The input signal electrode 51A is arranged between the first input-side arm waveguide 22 and the second input-side arm waveguide 32, and is electrically connected to the folded signal electrode 51C. The output signal electrode 51B is arranged between the first output-side arm waveguide 24A and the second output-side arm waveguide 34A, and is electrically connected to the folded signal electrode 51C. The folded signal electrode 51C electrically connects between the input signal electrode 51A and the output signal electrode 51B.

The first ground electrode 52 includes the first input-side ground electrode 52A that is located on the outer peripheral side, the first output-side ground electrode 52B that is located on the outer peripheral side, and the first folded ground electrode 52C that is located on the outer peripheral side. The first input-side ground electrode 52A is arranged in the vicinity of a side surface of the first input-side arm waveguide 22 located on the outer peripheral side, so as to face the input signal electrode 51A, and is electrically connected to the first folded ground electrode 52C. The first output-side ground electrode 52B is arranged in the vicinity of a side surface of the first output-side arm waveguide 24A located on the outer peripheral side, so as to face the output signal electrode 51B, and is electrically connected to the first folded ground electrode 52C. The first folded ground electrode 52C that is located on the outer peripheral side electrically connects between the first input-side ground electrode 52A and the first output-side ground electrode 52B.

The second ground electrode 53 includes the second input-side ground electrode 53A that is located on the inner peripheral side, the second output-side ground electrode 53B that is located on the inner peripheral side, and the second folded ground electrode 53C that is located on the inner peripheral side. The second input-side ground electrode 53A is arranged in the vicinity of a side surface of the second input-side arm waveguide 32 located on the inner peripheral side, so as to face the input signal electrode 51A, and is electrically connected to the second folded ground electrode 53C. The second output-side ground electrode 53B is arranged in the vicinity of a side surface of the second output-side arm waveguide 34A located on the inner peripheral side, so as to face the output signal electrode 51B, and is electrically connected to the second folded ground electrode 53C. The second folded ground electrode 53C that is located on the inner peripheral side electrically connects between the second input-side ground electrode 53A and the second output-side ground electrode 53B.

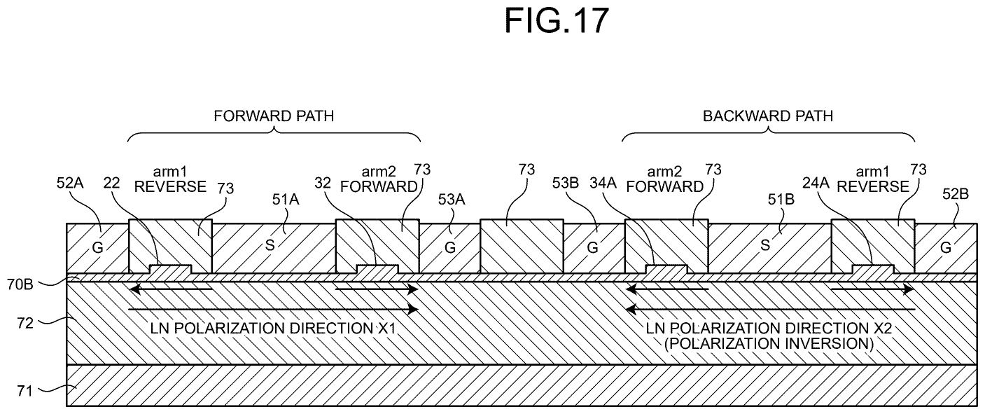

FIG. 17 is a schematic cross-sectional view illustrating an example of a cross-sectional portion taken along a line A-A illustrated in FIG. 16. A modulator main body 4B illustrated in FIG. 17 includes the Si substrate 71, the lower clad layer 72, the upper clad layer 73, and the electrode 50. The modulator main body 4B includes the first input-side arm waveguide 22 and that is located on the outer peripheral side and the second input-side arm waveguide 32 that is located on the inner peripheral side, which are arranged on the first layer 70A of the upper clad layer 73. The modulator main body 4B includes the first output-side arm waveguide 24A that is located on the outer peripheral side and the second output-side arm waveguide 34A that is located on the inner peripheral side, which are arranged on the first layer 70A. The electrode 50 that is arranged on the upper clad layer 73 includes the input signal electrode 51A, the first input-side ground electrode 52A that is located on the outer peripheral side, and the second input-side ground electrode 53A that is located on the inner peripheral side. Furthermore, the electrode 50 includes the output signal electrode 51B, the first output-side ground electrode 52B that is located on the outer peripheral side, and the second output-side ground electrode 53B that is located on the inner peripheral side.

The input signal electrode 51A is arranged between the first input-side arm waveguide 22 and the second input-side arm waveguide 32. The first input-side ground electrode 52A is arranged in the vicinity of a side surface of the first input-side arm waveguide 22 on the opposite side of the input signal electrode 51A. The second input-side ground electrode 53A is arranged in the vicinity of a side surface of the second input-side arm waveguide 32 on the opposite side of the input signal electrode 51A.

The output signal electrode 51B is arranged between the first output-side arm waveguide 24A and the second output-side arm waveguide 34A. The first output-side ground electrode 52B is arranged in the vicinity of a side surface of the first output-side arm waveguide 24A on the opposite side of the output signal electrode 51B. The second output-side ground electrode 53B is arranged in the vicinity of a side surface of the second output-side arm waveguide 34A on the opposite side of the output signal electrode 51B.

The polarization direction X of the modulator main body 4 is reversed between a forward path and a backward path. The first input-side arm waveguide 22 modulates signal light in accordance with an electrical signal in a reverse direction from the input signal electrode 51A to the first input-side ground electrode 52A. The second input-side arm waveguide 32 modulates signal light in accordance with an electrical signal in a forward direction from the input signal electrode 51A to the second input-side ground electrode 53A.

In contrast, the first output-side arm waveguide 24A modulates signal light in accordance with an electrical signal in a reverse direction from the output signal electrode 51B to the first output-side ground electrode 52B. The second output-side arm waveguide 34A modulates signal light in accordance with the electrical signal in a forward direction from the output signal electrode 51B to the second output-side ground electrode 53B.

In other words, the first input-side arm waveguide 22 and the first output-side arm waveguide 24A modulate signal light in accordance with the electrical signal in the same reverse direction. The second input-side arm waveguide 32 and the second output-side arm waveguide 34A modulate the signal light in accordance with the electrical signal in the same forward direction. The electrical signal in the same direction is applied in the forward path and the backward path, so that it is possible to improve modulation efficiency.

In the optical modulator 1B of the third embodiment, a polarization direction X1 of a thin-film LN of the first input-side arm waveguide 22 and the second input-side arm waveguide 32 is reversed from a polarization direction X2 of a thin-film LN of the first output-side arm waveguide 24A and the second output-side arm waveguide 34A. As a result, both of the modulation electric field and the polarization direction are reverse directions between the first input-side arm waveguide 22 and the first output-side arm waveguide 24A, so that it is possible to modulate the phase in the same direction before and after the folding. Similarly, both of the modulation electric field and the polarization direction are forward directions between the second input-side arm waveguide 32 and the second output-side arm waveguide 34A, so that it is possible to modulate the phase in the same direction before and after the folding. In addition, it is possible to realize push-pull operation in which the phase is changed in the opposite direction of the first input-side arm waveguide 22 and the first output-side arm waveguide 24A.

Meanwhile, in the optical modulator 1 of the first embodiment, the example has been described in which the single folded portion is provided; however, it may be possible to provide a plurality of folded portions, such as two folded portions, and this embodiment will be described below as a fourth embodiment.

### (d) Fourth Embodiment

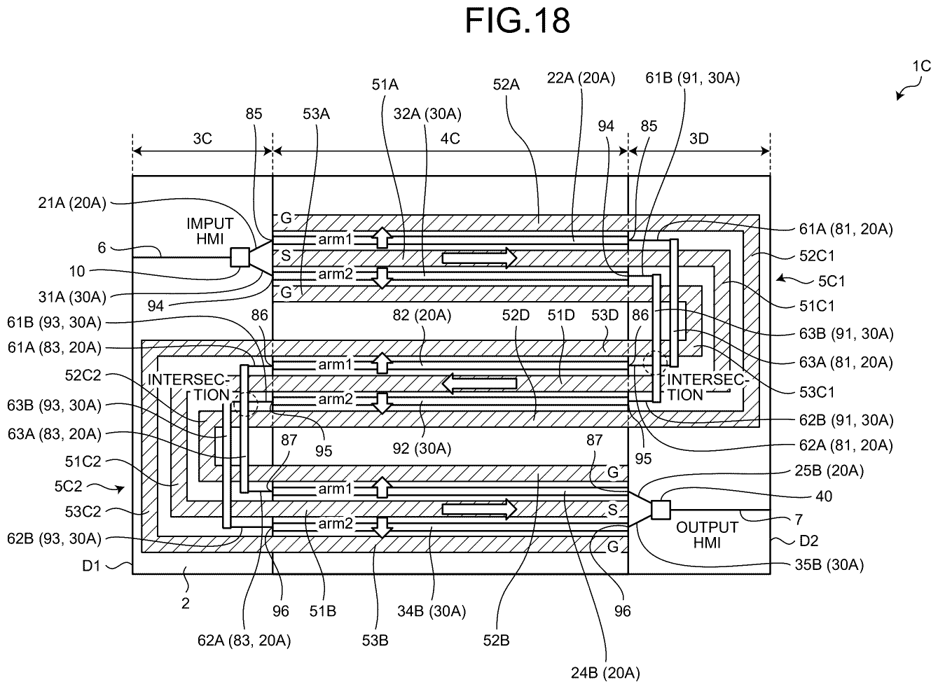

FIG. 18 is a schematic plan view illustrating an example of an optical modulator 1C of the fourth embodiment. Meanwhile, the same components as those of the optical modulator 1 of the first embodiment are denoted by the same reference symbols, and explanation of the same components and the same operation will be omitted. The optical modulator 1C of the fourth embodiment is different from the optical modulator 1 in that, a plurality of folded portions, such as two folded portions, are provided, signal light is input from one end face D1 of a chip of the optical modulator 1C, and signal light is output from another end face D2 of the optical modulator 1C that is located opposite to the one end face D1.

The optical modulator 1C includes the Si photonics substrate 2, an input MMI 3C, a modulator main body 4C, a first folded portion 5C1, a second folded portion 5C2, and an output MMI 3D. The input MMI 3C includes an input waveguide 6 that inputs light to the optical modulator 1C. The output MMI 3D includes the output waveguide 7 that outputs signal light from the optical modulator 1C. The optical modulator 1C includes the first coupler 10, a first waveguide 20A, a second waveguide 30A, the second coupler 40, and the electrode 50. The first coupler 10 is a coupler that is arranged on the Si substrate 71, that splits signal light coming from the input waveguide 6 into beams of light, and that outputs the split light to the first input waveguide 21A and the second input waveguide 31A.

The first waveguide 20A is arranged on the Si substrate 71 and connected to one output of the first coupler 10. The second waveguide 30A is arranged on the Si substrate 71 and connected to the other output of the first coupler 10. The second coupler 40 is a coupler that is arranged on the Si substrate 71, couples signal light coming from the first output waveguide 25 of the first waveguide 20A and signal light coming from the second output waveguide 35 of the second waveguide 30A, and outputs the coupled signal light to the output waveguide 7. The electrode 50 is a GSG electrode that applies an electrical signal to the first waveguide 20A and the second waveguide 30A.

The first waveguide 20A includes the first input waveguide 21A, a first input-side arm waveguide 22A, a first input-side folded waveguide 81, a first intermediate arm waveguide 82, and a first output-side folded waveguide 83. The first waveguide 20A includes a first output-side arm waveguide 24B, a first output waveguide 25B, a first input-side modulation unit transition unit 85, a first intermediate-side modulation unit transition unit 86, and a first output-side modulation unit transition unit 87.

The first input waveguide 21A is an Si waveguide that connects between the first coupler 10 and the first input-side arm waveguide 22A. The first input-side arm waveguide 22A is a straight arm waveguide that is made of thin-film LN as a high EO material and that connects between the first input waveguide 21A and the first input-side folded waveguide 81. The first input-side folded waveguide 81 is a waveguide that has a folded structure and that connects between the first input-side arm waveguide 22A and the first intermediate arm waveguide 82. Meanwhile, the first input-side folded waveguide 81 has the same structure as the first folded waveguide 23 illustrated in FIG. 2, for example.

The first intermediate arm waveguide 82 is a straight arm waveguide that is made of thin-film LN as a high EO material and that connects between the first input-side folded waveguide 81 and the first output-side folded waveguide 83. The first output-side folded waveguide 83 is a waveguide that has a folded structure and that connects between the first intermediate arm waveguide 82 and the first output-side arm waveguide 24B. Meanwhile, the first output-side folded waveguide 83 has the same structure as the first folded waveguide 23 illustrated in FIG. 2, for example.

The first output-side arm waveguide 24B is a straight arm waveguide that is made of thin-film LN as a high EO material and that connects between the first output-side folded waveguide 83 and the first output waveguide 25B. The first output waveguide 25B is an Si waveguide that connects between the first output-side arm waveguide 24B and the second coupler 40.

The first input-side modulation unit transition unit 85 includes an output end of the first input waveguide 21A and an input end of the first input-side arm waveguide 22A, and allows transition of signal light between the first input waveguide 21A and the first input-side arm waveguide 22A. Furthermore, the first input-side modulation unit transition unit 85 includes an output end of the first input-side arm waveguide 22A and an input end of the first input-side folded waveguide 81, and allows transition of signal light between the first input-side arm waveguide 22A and the first input-side folded waveguide 81.

The first intermediate-side modulation unit transition unit 86 includes an output end of the first input-side folded waveguide 81 and an input end of the first intermediate arm waveguide 82, and allows transition of signal light between the first input-side folded waveguide 81 and the first intermediate arm waveguide 82. The first intermediate-side modulation unit transition unit 86 includes an output end of the first intermediate arm waveguide 82 and an input end of the first output-side folded waveguide 83, and allows transition of signal light between the first intermediate arm waveguide 82 and the first output-side folded waveguide 83.

The first output-side modulation unit transition unit 87 includes an output end of the first output-side folded waveguide 83 and an input end of the first output-side arm waveguide 24B, and allows transition of signal light between the first output-side folded waveguide 83 and the first output-side arm waveguide 24B. The first output-side modulation unit transition unit 87 includes an output end of the first output-side arm waveguide 24B and an input end of the first output waveguide 25B, and allows transition of signal light between the first output-side arm waveguide 24B and the first output waveguide 25B.

The second waveguide 30A includes the second input waveguide 31A, a second input-side arm waveguide 32A, a second input-side folded waveguide 91, a second intermediate arm waveguide 92, and a second output-side folded waveguide 93. Furthermore, the second waveguide 30A includes a second output-side arm waveguide 34B, a second output waveguide 35B, a second input-side modulation unit transition unit 94, a second intermediate-side modulation unit transition unit 95, and a second output-side modulation unit transition unit 96.

The second input waveguide 31A is an Si waveguide that connects between the first coupler 10 and the second input-side arm waveguide 32A. The second input-side arm waveguide 32A is a straight arm waveguide that is made of thin-film LN as a high EO material and that connects between the second input waveguide 31A and the second input-side folded waveguide 91. The second input-side folded waveguide 91 is a waveguide that has a folded structure and that connects between the second input-side arm waveguide 32A and the second intermediate arm waveguide 92. Meanwhile, the second input-side folded waveguide 91 has the same structure as the second folded waveguide 33 illustrated in FIG. 2, for example.

The second intermediate arm waveguide 92 is a straight arm waveguide that is made of thin-film LN as a high EO material and that connects between the second input-side folded waveguide 91 and the second output-side folded waveguide 93. The second output-side folded waveguide 93 is a waveguide that has a folded structure and that connects between the second intermediate arm waveguide 92 and the second output-side arm waveguide 34B. The second output-side arm waveguide 34B is a straight waveguide that is made of thin-film LN as a high EO material and that connects between the second output-side folded waveguide 93 and the second output waveguide 35B.

The second input-side modulation unit transition unit 94 includes an output end of the second input waveguide 31A and an input end of the second input-side arm waveguide 32A, and allows transition of signal light between the second input waveguide 31A and the second input-side arm waveguide 32A. The second input-side modulation unit transition unit 94 includes an output end of the second input-side arm waveguide 32A and an input end of the second input-side folded waveguide 91, and allows transition of signal light between the second input-side arm waveguide 32A and the second input-side folded waveguide 91.

The second intermediate-side modulation unit transition unit 95 includes an output end of the second input-side folded waveguide 91 and an input end of the second intermediate arm waveguide 92, and allows transition of signal light between the second input-side folded waveguide 91 and the second intermediate arm waveguide 92. The second intermediate-side modulation unit transition unit 95 includes an output end of the second intermediate arm waveguide 92 and an input end of the second output-side folded waveguide 93, and allows transition of signal light between the second intermediate arm waveguide 92 and the second output-side folded waveguide 93.

The second output-side modulation unit transition unit 96 includes an output end of the second output-side folded waveguide 93 and an input end of the second output-side arm waveguide 34B, and allows transition of signal light between the second output-side folded waveguide 93 and the second output-side arm waveguide 34B. The second output-side modulation unit transition unit 96 includes an output end of the second output-side arm waveguide 34B and an input end of the second output waveguide 35B, and allows transition of signal light between the second output-side arm waveguide 34B and the second output waveguide 35B.

The first input-side arm waveguide 22A, the second input-side arm waveguide 32A, the first output-side arm waveguide 24B, and the second output-side arm waveguide 34B are waveguides that include a material with high EO characteristics as compared to the high refractive index waveguide that is formed on the Si substrate 71. The first intermediate arm waveguide 82 and the second intermediate arm waveguide 92 are waveguides that include a material with high EO characteristics as compared to the high refractive index waveguide that is formed on the Si substrate 71. Further, the first input-side folded waveguide 81, the second input-side folded waveguide 91, the first output-side folded waveguide 83, and the second output-side folded waveguide 93 are waveguides that include a material that has a low refractive index as compared to the high refractive index waveguide that is formed on the Si substrate 71.

The first waveguide 20A includes the first input-side arm waveguide 22A that is located on the outer peripheral side, the first input-side folded waveguide 81 that is located on the outer peripheral side, and the first intermediate arm waveguide 82 that is located on the left side in FIG. 18. Further, the first waveguide 20A includes the first output-side folded waveguide 83 that is located on the inner peripheral side and the first output-side arm waveguide 24B that is located on the inner peripheral side.

The second waveguide 30A includes the second input-side arm waveguide 32A that is located on the inner peripheral side, the second input-side folded waveguide 91 that is located on the inner peripheral side, and the second intermediate arm waveguide 92 that is located on the right side in FIG. 18. Further, the second waveguide 30A includes the second output-side folded waveguide 93 that is located on the inner peripheral side and the second output-side arm waveguide 34B that is located on the outer peripheral side.

The signal electrode 51 includes the input signal electrode 51A, an input-side folded signal electrode 51C1, an intermediate-side signal electrode 51D, an output-side folded signal electrode 51C2, and the output signal electrode 51B. The input signal electrode 51A is arranged between the first input-side arm waveguide 22A and the second input-side arm waveguide 32A, and is electrically connected to the input-side folded signal electrode 51C1. The input-side folded signal electrode 51C1 is electrically connected to the intermediate-side signal electrode 51D. The intermediate-side signal electrode 51D is arranged between the first intermediate arm waveguide 82 and the second intermediate arm waveguide 92, and is electrically connected to the output-side folded signal electrode 51C2. The output-side folded signal electrode 51C2 is electrically connected to the output signal electrode 51B. The output signal electrode 51B is arranged between the first output-side arm waveguide 24B and the second output-side arm waveguide 34B, and is electrically connected to the output-side folded signal electrode 51C2.

The first ground electrode 52 includes the first input-side ground electrode 52A that is located on the outer peripheral side, a first input-side folded ground electrode 52C1 that is located on the outer peripheral side, and a first intermediate-side ground electrode 52D. Further, the first ground electrode 52 includes a first output-side folded ground electrode 52C2 that is located on the inner peripheral side and the first output-side ground electrode 52B that is located on the inner peripheral side. The first input-side ground electrode 52A is arranged in the vicinity of a side surface of the first input-side arm waveguide 22A located on the outer peripheral side, so as to face the input signal electrode 51A, and is electrically connected to the first input-side folded ground electrode 52C1 that is located on the outer peripheral side. The first input-side folded ground electrode 52C1 electrically connects between the first input-side ground electrode 52A and the first intermediate-side ground electrode 52D. The first intermediate-side ground electrode 52D is arranged in the vicinity of a side surface of the first intermediate arm waveguide 82 located on the left side in FIG. 18, so as to face the intermediate-side signal electrode 51D, electrically connects between the first input-side folded ground electrode 52C1 and the first output-side folded ground electrode 52C2. The first output-side folded ground electrode 52C2 electrically connects between the first intermediate-side ground electrode 52D and the first output-side ground electrode 52B. The first output-side ground electrode 52B is arranged in the vicinity of a side surface of the first output-side arm waveguide 24B located on the inner peripheral side, so as to face the output signal electrode 51B, and is electrically connected to the first output-side folded ground electrode 52C2.

The second ground electrode 53 includes the second input-side ground electrode 53A that is located on the inner peripheral side, a second input-side folded ground electrode 53C1 that is located on the inner peripheral side, and a second intermediate-side ground electrode 53D that is located on the inner peripheral side. Further, the second ground electrode 53 includes a second output-side folded ground electrode 53C2 that is located on the outer peripheral side and the second output-side ground electrode 53B that is located on the outer peripheral side. The second input-side ground electrode 53A is arranged in the vicinity of a side surface of the second input-side arm waveguide 32A located on the inner peripheral side, so as to face the input signal electrode 51A, and is electrically connected to the second input-side folded ground electrode 53C1 that is located on the inner peripheral side. The second input-side folded ground electrode 53C1 electrically connects between the second input-side ground electrode 53A and the second intermediate-side ground electrode 53D. The second intermediate-side ground electrode 53D is arranged in the vicinity of a side surface of the second intermediate arm waveguide 92 located on the right side in FIG. 18, so as to face the intermediate-side signal electrode 51D, and electrically connects between the second input-side folded ground electrode 53C1 and the second output-side folded ground electrode 53C2. The second output-side folded ground electrode 53C2 electrically connects between the second intermediate-side ground electrode 53D and the second output-side ground electrode 53B. The second output-side ground electrode 53B is arranged in the vicinity of a side surface of the second output-side arm waveguide 34B located on the outer peripheral side, so as to face the output signal electrode 51B, and is electrically connected to the second output-side folded ground electrode 53C2.

The first input-side folded waveguide 81 includes the first input-side high refractive index waveguide 61A, the first output-side high refractive index waveguide 62A, the first low refractive index waveguide 63A, the first input-side first-stage transition unit 64A1, and the first output-side first-stage transition unit 64A2. The first input-side high refractive index waveguide 61A is, for example, an Si waveguide that is formed on the first layer 70A on the Si substrate 71 and that is connected to the first input-side arm waveguide 22A. The first output-side high refractive index waveguide 62A is, for example, an Si waveguide that is formed on the first layer 70A and that is connected to the first intermediate arm waveguide 82. The first low refractive index waveguide 63A is, for example, a SiN waveguide that is formed on the second layer 70B on the Si substrate 71 and that connects between the first input-side high refractive index waveguide 61A and the first output-side high refractive index waveguide 62A.

The first input-side first-stage transition unit 64A1 includes the output end of the first input-side high refractive index waveguide 61A and the input end of the first low refractive index waveguide 63A, and allows transition of signal light between the first input-side high refractive index waveguide 61A and the first low refractive index waveguide 63A. The first output-side first-stage transition unit 64A2 includes the output end of the first low refractive index waveguide 63A and the input end of the first output-side high refractive index waveguide 62A, and allows transition of signal light between the first low refractive index waveguide 63A and the first output-side high refractive index waveguide 62A.

The second input-side folded waveguide 91 includes the second input-side high refractive index waveguide 61B, the second output-side high refractive index waveguide 62B, the second low refractive index waveguide 63B, the second input-side first-stage transition unit 64B1, and the second output-side first-stage transition unit 64B2. The second input-side high refractive index waveguide 61B is, for example, an Si waveguide that is formed on the first layer 70A on the Si substrate 71 and that is connected to the second input-side arm waveguide 32A. The second output-side high refractive index waveguide 62B is, for example, an Si waveguide that is formed on the first layer 70A and that is connected to the second intermediate arm waveguide 92. The second low refractive index waveguide 63B is, for example, a SiN waveguide that is formed on the second layer 70B on the Si substrate 71 and that connects between the second input-side high refractive index waveguide 61B and the second output-side high refractive index waveguide 62B.

The second input-side first-stage transition unit 64B1 includes the output end of the second input-side high refractive index waveguide 61B and the input end of the second low refractive index waveguide 63B, and allows transition of signal light between the second input-side high refractive index waveguide 61B and the second low refractive index waveguide 63B. The second output-side first-stage transition unit 64B2 includes the output end of the second low refractive index waveguide 63B and the input end of the second output-side high refractive index waveguide 62B, and allows transition of signal light between the second low refractive index waveguide 63B and the second output-side high refractive index waveguide 62B. The first output-side high refractive index waveguide 62A connects between the first low refractive index waveguide 63A and the first intermediate arm waveguide 82 across the second low refractive index waveguide 63B.

The first output-side folded waveguide 83 includes the first input-side high refractive index waveguide 61A, the first output-side high refractive index waveguide 62A, the first low refractive index waveguide 63A, the first input-side first-stage transition unit 64A1, and the first output-side first-stage transition unit 64A2. The first input-side high refractive index waveguide 61A is, for example, an Si waveguide that is formed on the first layer 70A on the Si substrate 71 and that is connected to the first intermediate arm waveguide 82. The first output-side high refractive index waveguide 62A is, for example, an Si waveguide that is formed on the first layer 70A and that is connected to the first output-side arm waveguide 24B. The first low refractive index waveguide 63A is, for example, a SiN waveguide that is formed on the second layer 70B on the Si substrate 71 and that connects between the first input-side high refractive index waveguide 61A and the first output-side high refractive index waveguide 62A.

The first input-side first-stage transition unit 64A1 includes the output end of the first input-side high refractive index waveguide 61A and the input end of the first low refractive index waveguide 63A, and allows transition of signal light between the first input-side high refractive index waveguide 61A and the first low refractive index waveguide 63A. The first output-side first-stage transition unit 64A2 includes the output end of the first low refractive index waveguide 63A and the input end of the first output-side high refractive index waveguide 62A, and allows transition of signal light between the first low refractive index waveguide 63A and the first output-side high refractive index waveguide 62A.

The second output-side folded waveguide 93 includes the second input-side high refractive index waveguide 61B, the second output-side high refractive index waveguide 62B, the second low refractive index waveguide 63B, the second input-side first-stage transition unit 64B1, and the second output-side first-stage transition unit 64B2. The second input-side high refractive index waveguide 61B is, for example, an Si waveguide that is formed on the first layer 70A on the Si substrate 71 and that is connected to the second intermediate arm waveguide 92. The second output-side high refractive index waveguide 62B is, for example, an Si waveguide that is formed on the first layer 70A and that is connected to the second output-side arm waveguide 34B. The second low refractive index waveguide 63B is, for example, a SiN waveguide that is formed on the second layer 70B on the Si substrate 71 and that connects between the second input-side high refractive index waveguide 61B and the second output-side high refractive index waveguide 62B.

The second input-side first-stage transition unit 64B1 includes the output end of the second input-side high refractive index waveguide 61B and the input end of the second low refractive index waveguide 63B, and allows transition of signal light between the second input-side high refractive index waveguide 61B and the second low refractive index waveguide 63B. The second output-side first-stage transition unit 64B2 includes the output end of the second low refractive index waveguide 63B and the input end of the second output-side high refractive index waveguide 62B, and allows transition of signal light between the second low refractive index waveguide 63B and the second output-side high refractive index waveguide 62B. The second input-side high refractive index waveguide 61B connects between the second intermediate arm waveguide 92 and the second low refractive index waveguide 63B across the first low refractive index waveguide 63A.

The first input-side arm waveguide 22A modulates signal light in accordance with an electrical signal in a reverse direction from the input signal electrode 51A to the first input-side ground electrode 52A. The second input-side arm waveguide 32A modulates signal light in accordance with an electrical signal in a forward direction from the input signal electrode 51A to the second input-side ground electrode 53A.

The first intermediate arm waveguide 82 modulates signal light in accordance with an electrical signal in a reverse direction from the intermediate-side signal electrode 51D to the first intermediate-side ground electrode 52D. The second intermediate arm waveguide 92 modulates signal light in accordance with an electrical signal in a forward direction from the intermediate-side signal electrode 51D to the second intermediate-side ground electrode 53D.

The first output-side arm waveguide 24B modulates signal light in accordance with an electrical signal in a reverse direction from the output signal electrode 51B to the first output-side ground electrode 52B. The second output-side arm waveguide 34B modulates signal light in accordance with an electrical signal in a forward direction from the output signal electrode 51B to the second output-side ground electrode 53B.

In other words, the first input-side arm waveguide 22A, the first intermediate arm waveguide 82, and the first output-side arm waveguide 24B modulate signal light in accordance with the electrical signal in the same reverse direction modulates the signal light. The second input-side arm waveguide 32A, the second intermediate arm waveguide 92, and the second output-side arm waveguide 34B modulate signal light in accordance with the electrical signal in the same forward direction. The electrical signal in the same direction is applied in the forward path, the intermediate path, and the backward path, so that it is possible to improve modulation efficiency.

In the optical modulator 1C of the fourth embodiment, signal light is input from the one end face D1 of an optical chip, and signal light is output from the other end face D2 of the optical chip. As a result, it is possible to arrange the plurality of folded optical modulators 1C in parallel in simple layout.

In the optical modulator 1C, by providing two folded portions, it is possible to increase the length of the modulator main body 4C without changing a chip length of the optical modulator 1C. As a result, it is possible to realize highly efficient (low Vpi) operation.

Meanwhile, it is possible to adopt a Dual-Polarization In-Phase Quafratur (DP-IQ) in which the four optical modulators 1C of the fourth embodiment are mounted, and this embodiment will be described below as a fifth embodiment.

### (e) Fifth Embodiment

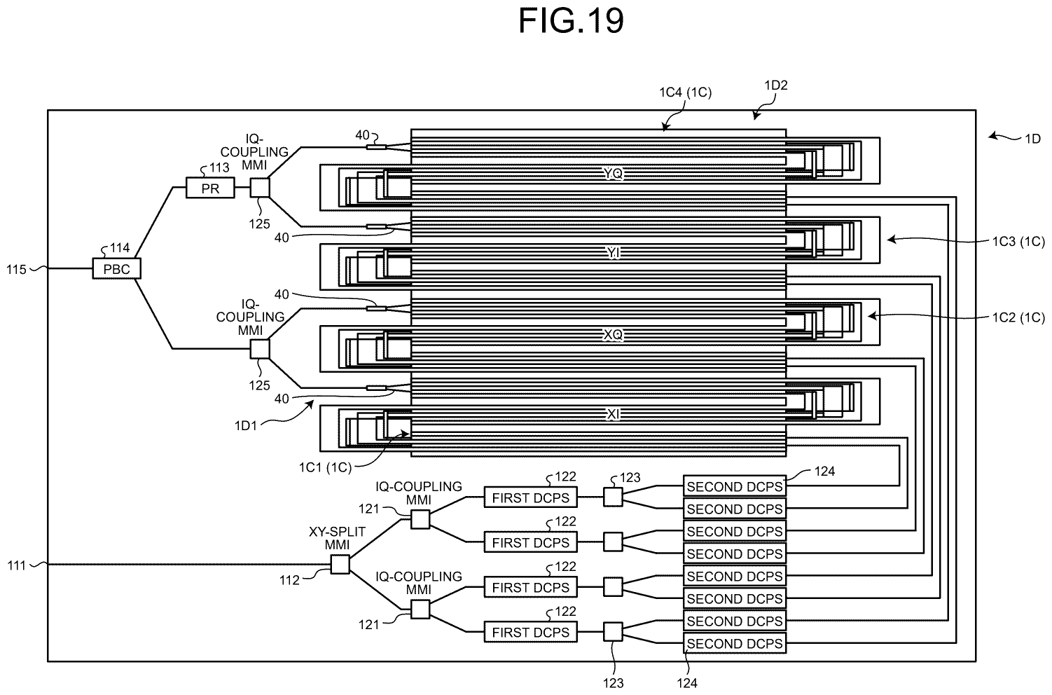

FIG. 19 is a diagram for explaining an example of a DP-IQ modulator 1D of the fifth embodiment. The same components as those of the optical modulator 1C illustrated in FIG. 18 are denoted by the same reference symbols, and explanation of the same components and the same operation will be omitted. The DP-IQ modulator 1D illustrated in FIG. 19 includes the four optical modulators 1C of the fourth embodiment that are arranged in parallel. The DP-IQ modulator 1D includes an LD input port 111, a split portion 112, an IQ modulator 1D1 for an X-polarization component, an IQ modulator 1D2 for a Y-polarization component, and a Polarization Rotator (PR) 113. Further, the DP-IQ modulator 1D includes a Polarization Beam Combiner (PBC) 114 and a transmission light output port 115.

The split portion 112 is an XY-split MMI that optically splits input light that comes from the input waveguide 6, and outputs the optically split signal light to the IQ modulator 1D1 for the X-polarization component and the IQ modulator 1D2 for the Y-polarization component. The IQ modulator 1D1 for the X-polarization component includes a first split portion 121, two first Direct Current Phase Shifters (DCPSs) 122, two second split portions 123, and four second DCPSs 124. The IQ modulator 1D1 for the X-polarization component includes an optical modulator 1C1 of the I-component, an optical modulator 1C2 of the Q-component, and a first multiplexing unit 125.

The first split portion 121 in the IQ modulator 1D1 for the X-polarization component is an IQ-split MMI that optically splits signal light of the X-polarization component that comes from the split portion 112 to signal light of the I-component and signal light of the Q-component. The first split portion 121 outputs the optically split signal light of the I-component to the first DCPS 122. The first DCPS 122 is a phase shifter, such as a heater for heating the Si waveguide, which shifts a phase of the signal light of the I-component, for example. The first DCPS 122 is arranged just below the Si waveguide, and adjusts the phase of the signal light that is guided through the Si waveguide by changing the refractive index of the Si waveguide by heating by the heater. The first DCPS 122 outputs the signal light of the I-component that is subjected to the phase shift to the second split portion 123.

The second split portion 123 outputs the signal light of the I-component that is subjected to the phase shift and that comes from the first DCPS 122 to each of the second DCPSs 124. The second DCPS 124 is a phase shifter, such as a heater for heating the Si waveguide, which shifts a phase of the signal light of the I-component, for example. The second DCPS 12 is arranged just below the Si waveguide, and adjusts the phase of the signal light that is guided through the Si waveguide by changing the refractive index of the Si waveguide by heating by the heater. The second DCPS 124 outputs the signal light of the I-component that is subjected to the phase shift to the optical modulator 1C1 of the I-component of the X-polarization component. The optical modulator 1C1 of the I-component of the X-polarization component modulates the signal light of the I-component of the X-polarization component, and outputs the modulated signal light of the I-component of the X-polarization component to the first multiplexing unit 125 for the X-polarization component.

The first split portion 121 in the IQ modulator 1D1 for the X-polarization component outputs the optically split signal light of the Q-component to the first DCPS 122. The first DCPS 122 is a phase shifter, such as a heater for heating the Si waveguide, which shifts a phase of the signal light of the Q-component, for example. The first DCPS 122 outputs the signal light of the Q-component that is subjected to the phase shift to the second split portion 123. The second split portion 123 outputs the signal light of the Q-component that is subjected to the phase shift and that comes from the first DCPS 122 to each of the second DCPSs 124. The second DCPS 124 is a phase shifter, such as a heater for heating the Si waveguide, which shifts a phase of the signal light of the Q-component, for example. The second DCPS 124 outputs the signal light of the Q-component that is subjected to the phase shift to the optical modulator 1C2 of the Q-component of the X-polarization component. The optical modulator 1C2 of the Q-component of the X-polarization component modulates the signal light of the Q-component of the X-polarization component, and outputs the modulated signal light of the Q-component of the X-polarization component to the first multiplexing unit 125 for the X-polarization component. The first multiplexing unit 125 for the X-polarization component is an IQ-coupling MMI that couples the signal light of the I-component of the X-polarization component and the signal light of the Q-component of the X-polarization component.

The IQ modulator 1D2 for the Y-polarization component includes the first split portion 121, the two first DCPSs 122, the two second split portions 123, and the four second DCPSs 124. The IQ modulator 1D2 for the Y-polarization component includes an optical modulator 1C3 for an I-component, an optical modulator 1C4 for a Q-component, and the first multiplexing unit 125.

The first split portion 121 in the IQ modulator 1D2 for the Y-polarization component is an IQ-split MMI that splits signal light of the Y-polarization component that comes from the split portion 112 to signal light of the I-component and signal light of the Q-component. The first split portion 121 outputs the optically split signal light of the I-component to the first DCPS 122. The first DCPS 122 is a phase shifter, such as a heater for heating the Si waveguide, which shifts a phase of the signal light of the I-component, for example. The first DCPS 122 outputs the signal light of the I-component that is subjected to the phase shift to the second split portion 123. The second split portion 123 outputs the signal light of the I-component that is subjected to the phase shift and that comes from the first DCPS 122 to each of the second DCPSs 124. The second DCPS 124 is a phase shifter, such as a heater for heating the Si waveguide, which shifts a phase of the signal light of the I-component, for example. The second DCPS 124 outputs the signal light of the I-component that is subjected to the phase shift to the optical modulator 1C3 for the I-component of the Y-polarization component. The optical modulator 1C3 for the I-component of the Y-polarization component modulates the signal light of the I-component of the Y-polarization component, and outputs the modulated signal light of the I-component of the Y-polarization component to the first multiplexing unit 125 for the Y-polarization component.

The first split portion 121 in the IQ modulator 1D2 for the Y-polarization component outputs the optically split signal light of the Q-component to the first DCPS 122. The first DCPS 122 is a phase shifter, such as a heater for heating the Si waveguide, which shifts a phase of the signal light of the Q-component, for example. The first DCPS 122 outputs the signal light of the Q-component that is subjected to the phase shift to the second split portion 123. The second split portion 123 outputs the signal light of the Q-component that is subjected to the phase shift and that comes from the first DCPS 122 to each of the second DCPSs 124. The second DCPS 124 is a phase shifter, such as a heater for heating the Si waveguide, which shifts a phase of the signal light of the Q-component, for example. The second DCPS 124 outputs the signal light of the Q-component that is subjected to the phase shift to the optical modulator 1C4 for the Q-component of the Y-polarization component. The optical modulator 1C4 for the Q-component of the Y-polarization component modulates the signal light of the Q-component of the Y-polarization component, and outputs the modulated signal light of the Q-component of the Y-polarization component to the first multiplexing unit 125 for the Y-polarization component. The first multiplexing unit 125 for the Y-polarization component is an IQ-coupling MMI that couples the signal light of the I-component of the Y-polarization component and the signal light of the Q-component of the Y-polarization component.

The first multiplexing unit 125 for the X-polarization component couples the signal light of the I-component of the X-polarization component and the signal light of the Q-component of the X-polarization component, and the coupled signal light of the IQ-component of the X-polarization component to the PBC 114. The first multiplexing unit 125 for the Y-polarization component couples the signal light of the I-component of the Y-polarization component and the signal light of the Q-component of the Y-polarization component, and outputs the coupled signal light of the IQ-component of the Y-polarization component to the PR 113. The PR 113 polarizes and rotates the signal light of the IQ-component of the Y-polarization component, and outputs the polarized and rotated signal light of the IQ-component of the Y-polarization component to the PBC 114. The PBC 114 couples the signal light of the IQ-component of the X-polarization component and the polarized and rotated signal light of the IQ-component of the Y-polarization component, and outputs the coupled signal light of the XY-polarization component, as transmission light, to the transmission light output port 115.

The first split portion 121, the second split portion 123, and the first multiplexing unit 125 that constitute the optical modulator 1C are configured with Si waveguides by silicon photonics, and can be downsized by taking advantage of the characteristics of the silicon photonics. By forming, at the side of a silicon photonics element, a part of the two waveguides that are included in the optical modulator 1C, it is possible to implement the first DCPSs 122 and the second DCPSs 124, which are for appropriately adjusting the phase of the optical modulator 1C, by a heater that is formed on the waveguides. Furthermore, it is possible to realize a phase shifter that has a small size and low power consumption. The first DCPSs 122 and the second DCPSs 124 using the heater may be used not only for adjustment of the phase of the optical modulator 1C, but also for adjustment a phase between an I channel and a Q channel of the IQ modulator 1D1 (1D2).

The DP-IQ modulator 1D of the fifth embodiment incorporates therein the IQ modulator 1D1 for X polarization and the IQ modulator 1D2 for Y polarization. As a result, a propagation velocity of an electrical signal and a propagation velocity of light in the optical modulator 1C are substantially equalized, so that it is possible to improve velocity mismatching in the DP-IQ modulator 1D. Therefore, it is possible to avoid a situation in which an operating band of the DP-IQ modulator 1D is limited. In addition, the DP-IQ modulator 1D is able to improve velocity mismatching while ensuring a long length of action, so that it is possible to reduce half-wave voltage Vn, and it is possible to improve modulation efficiency of the DP-IQ modulator 1D.

The DP-IQ modulator 1D incorporates therein the IQ modulator 1D1 for X polarization and the IQ modulator 1D2 for Y polarization, and each of the optical modulators 1C is able to ensure the velocity matching and reduce a size of the folded portion. As a result, it is possible to reduce a total chip size of the DP-IQ modulator 1D.

Meanwhile, in the fifth embodiment, the DP-IQ modulator 1D is illustrated by way of example, but it may be possible to mount an optical receiver on the Si substrate 71 in addition to the DP-IQ modulator 1D, and this embodiment will be described below as a sixth embodiment.

### (f) Sixth Embodiment

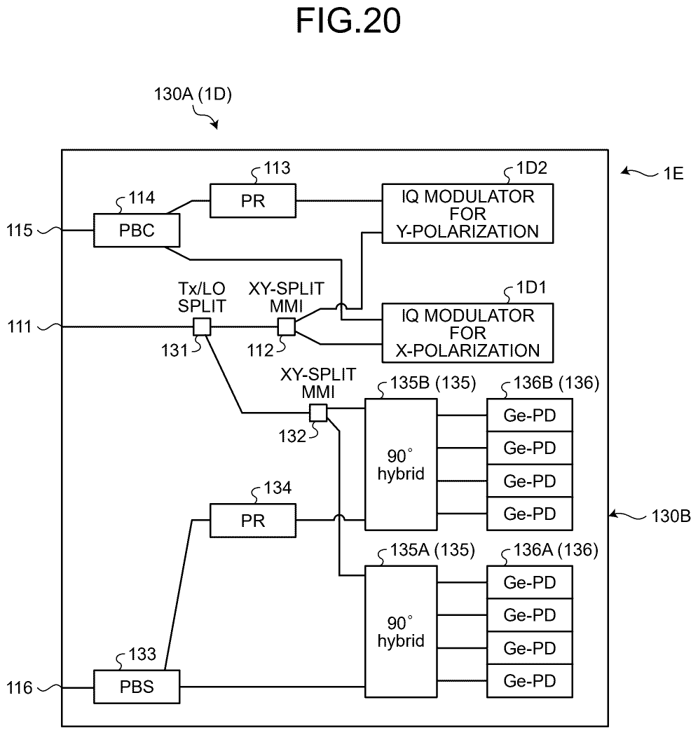

FIG. 20 is a diagram for explaining an example of the optical transceiver 1E of the sixth embodiment. Meanwhile, the same components as those of the DP-IQ modulator 1D illustrated in FIG. 19 are denoted by the same reference symbols, and explanation of the same components and the same operation will be omitted. The optical transceiver 1E illustrated in FIG. 20 is an optical integrated circuit that includes an optical modulator element 130A that includes the DP-IQ modulator 1D, and an optical receiver element 130B that receives a DP-QAM signal. In the optical transceiver 1E, the optical modulator element 130A and the optical receiver element 130B are integrated by using a silicon photonics technology. The optical transceiver 1E includes the LD input port 111, the transmission light output port 115, and a received light input port 116.

The received light input port 116 is an optical port that is arranged on the one end face D1 of the optical transceiver 1E and connects between an optical fiber that inputs received light (to be described later) and the optical receiver element 130B. The LD input port 111 is an optical port that is arranged on the one end face D1 of the optical transceiver 1E and connects between the optical modulator element 130A that receives input of local oscillator light from a light source (not illustrated) and the optical receiver element 130B. The transmission light output port 115 is an optical port that is arranged on the one end face D1 of the optical transceiver 1E and connects between an optical fiber that outputs transmission light and the optical modulator element 130A.

The optical modulator element 130A is, for example, the DP-IQ modulator 1D. The optical receiver element 130B is, for example, a coherent receiver. The optical receiver element 130B includes a third split portion 131, a fourth split portion 132, a Polarization Beam Splitter (PBS) 133, and a Polarization Rotator (PR) 134. Furthermore, the optical receiver element 130B includes a first optical hybrid circuit 135A (135) and a second optical hybrid circuit 135B (135). The optical receiver element 130B includes four first light receiving elements 136A (136) and four second light receiving elements 136B (136).

The third split portion 131 is a Tx/Lo-split MMI that optically splits light that comes from a light source that is connected to the LD input port 111. The third split portion 131 outputs one of the optically split light to the split portion 112 in the DP-IQ modulator 1D as an input light source of the optical modulator, and outputs the other one of the optically split light to each of the optical hybrid circuits 135 as local oscillator light of the optical receiver. The fourth split portion 132 optically splits the local oscillator light that comes from the third split portion 131 and outputs the split light to each of the optical hybrid circuits 135. The PBS 133 splits light that comes from the received light input port 116 to X-polarization received light and Y-polarization received light, outputs the X-polarization received light to the first optical hybrid circuit 135A, and outputs the Y-polarization received light to the PR 134. The PR 134 polarizes and rotates the Y-polarization received light by 90 degrees, and outputs the polarized and rotated Y-polarization received light to the second optical hybrid circuit 135B.

The first optical hybrid circuit 135A causes the X-polarization component of the received light to interfere with the local oscillator light and acquires optical signals of the I-component and the Q-component. The first optical hybrid circuit 135A outputs, from the X-polarization component, the optical signal of the I-component to the first light receiving elements 136A and the optical signal of the Q-component to the first light receiving elements 136A.

The second optical hybrid circuit 135B causes the Y-polarization component of the received light to interfere with the local oscillator light and acquires optical signals of the I-component and the Q-component. The second optical hybrid circuit 135B outputs, from the Y-polarization component, the optical signal of the I-component to the second light receiving elements 136B and the optical signal of the Q-component to the second light receiving elements 136B.

The first light receiving elements 136A are, for example, Si photonics Photo Detectors (Ge-PDs) that perform electrical conversion on the optical signal of the I-component of the X-polarization component that comes from the first optical hybrid circuit 135A, and output the electrical signal of the I-component that is obtained by the electrical conversion. The Ge-PD has a structure in which a Ge layer is arranged in a layer just below the Si waveguide. Further, the first light receiving elements 136A perform electrical conversion on the optical signal of the Q-component of the X-polarization component that comes from the first optical hybrid circuit 135A, and output the electrical signal of the Q-component that is obtained by the electrical conversion.

The second light receiving elements 136B are, for example, Si photonics Ge-PDs that perform electrical conversion on the optical signal of the I-component of the Y-polarization component that comes from the second optical hybrid circuit 135B, and output the electrical signal of the I-component that is obtained by the electrical conversion. The second light receiving elements 136B perform electrical conversion on the optical signal of the Q-component of the Y-polarization component that comes from the second optical hybrid circuit 135B, and output the electrical signal of the Q-component that is obtained by the electrical conversion.

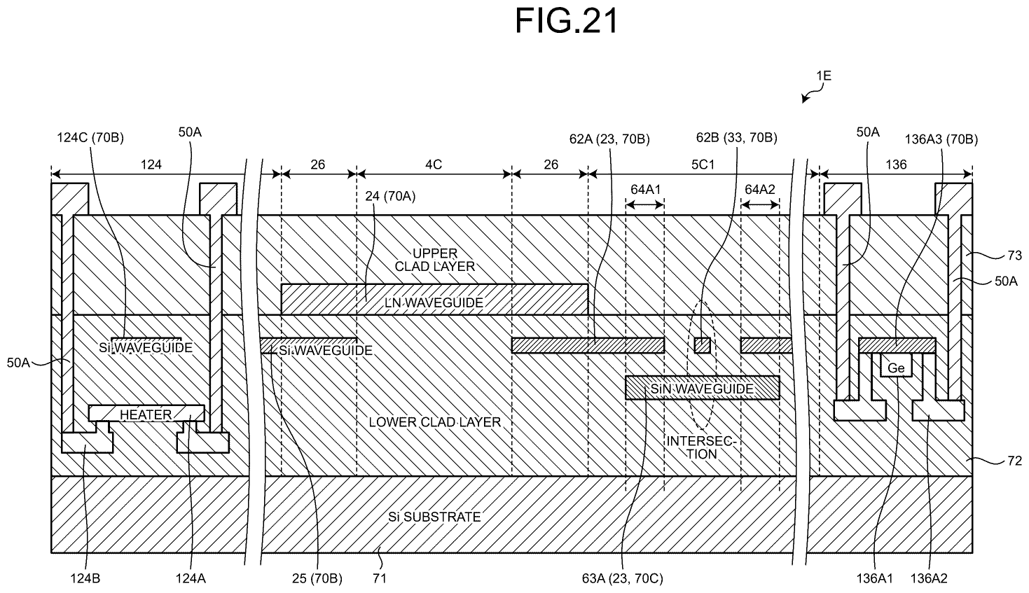

FIG. 21 is a schematic cross-sectional view illustrating an example of an optical transceiver 1E. The second DCPS 124 in the optical transceiver 1E illustrated in FIG. 21 includes the Si substrate 71, the lower clad layer 72 that is laminated on the Si substrate 71, and the upper clad layer 73 that is laminated on the lower clad layer 72. The second DCPS 124 includes an Si waveguide 124C that is arranged on the second layer 70B of the lower clad layer 72, a heater 124A that is arranged below the Si waveguide 124C in the lower clad layer 72, and heater terminals 124B that are connected to both ends of the heater 124A. Meanwhile, the heater terminals 124B are electrically connected to an electrode wiring 50A.

The optical modulator 1C in the optical transceiver 1E includes the first input-side modulation unit transition unit 26, the modulator main body 4C, and the first folded portion 5C1. The modulator main body 4C includes the Si substrate 71, the lower clad layer 72, and the upper clad layer 73. The modulator main body 4C includes the first input waveguide 21A that is arranged on the second layer 70B of the lower clad layer 72 and the first input-side high refractive index waveguide 61A that is arranged on the second layer 70B. The modulator main body 4C includes the first low refractive index waveguide 63A that is arranged on the third layer 70C of the lower clad layer 72 and the first input-side arm waveguide 22A that is arranged on the first layer 70A of the upper clad layer 73.

The first light receiving elements 136A in the optical transceiver 1E includes the Si substrate 71, the lower clad layer 72, and the upper clad layer 73. Each of the first light receiving elements 136A includes an Si waveguide 136A3 that is arranged on the second layer 70B of the lower clad layer 72, a Ge Layer 136A1 that is arranged below the Si waveguide 136A3, and PD terminals 136A2 that are connected to both ends of the Si waveguide 136A3. Meanwhile, the PD terminals 136A2 are electrically connected to the electrode wiring 50A.

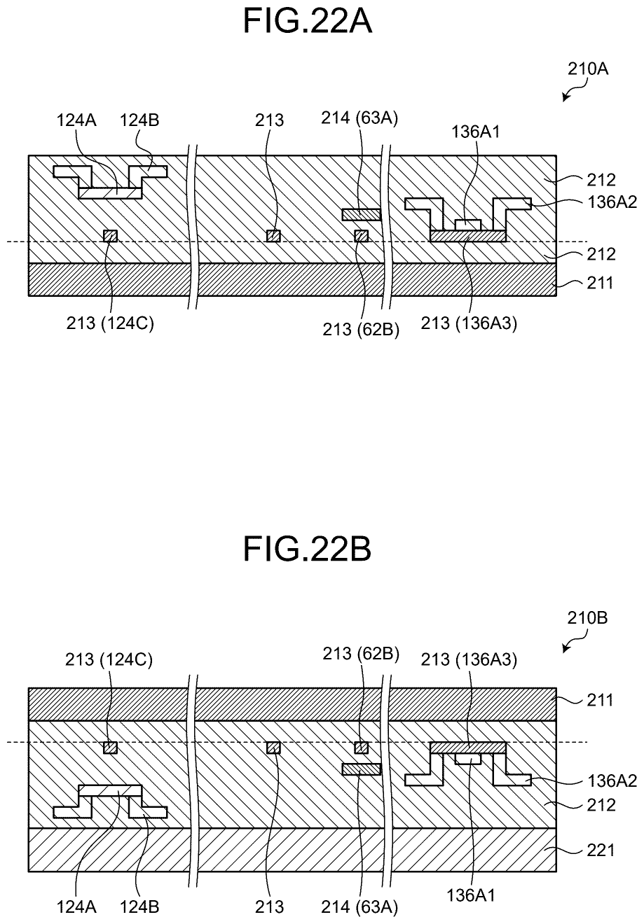

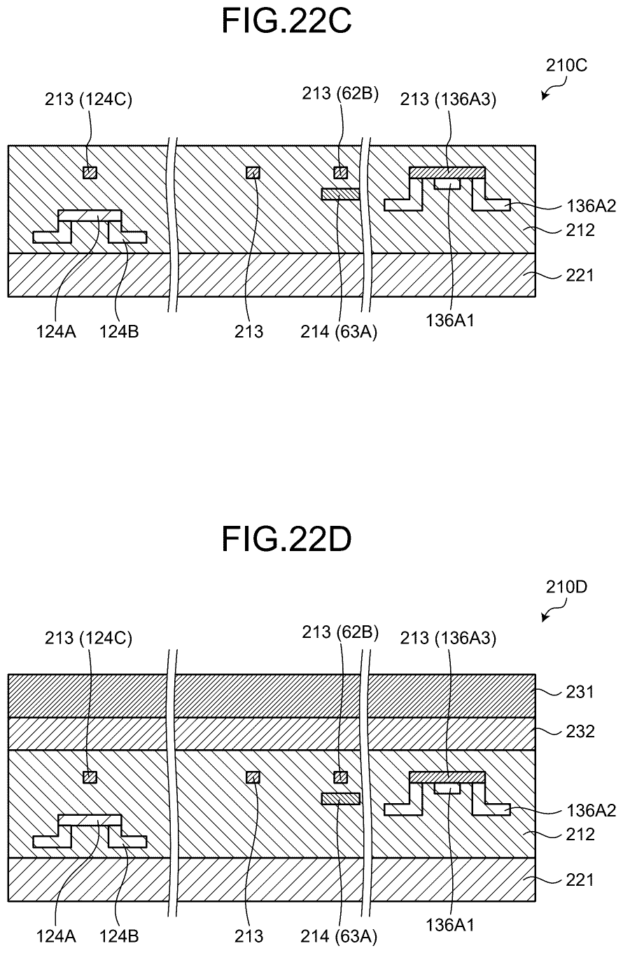

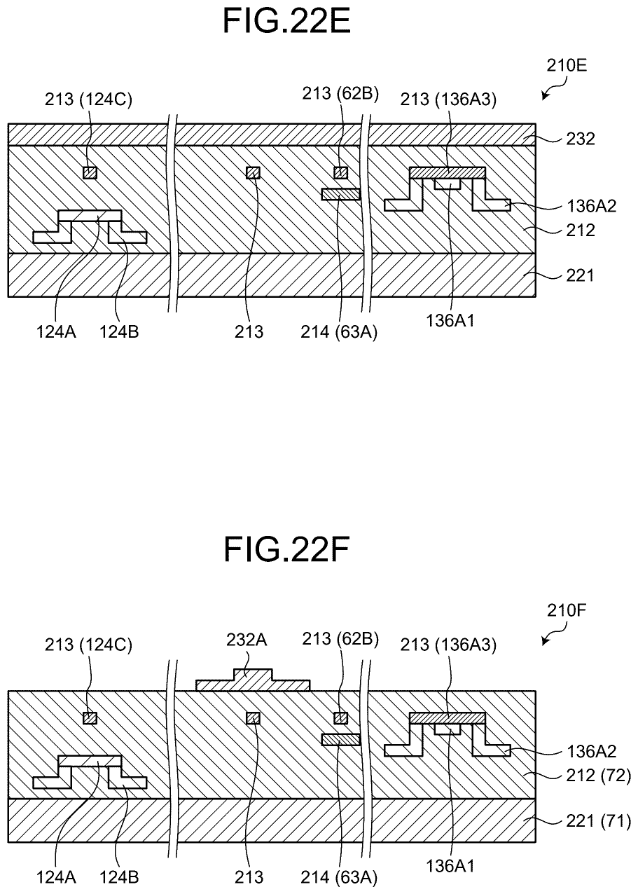

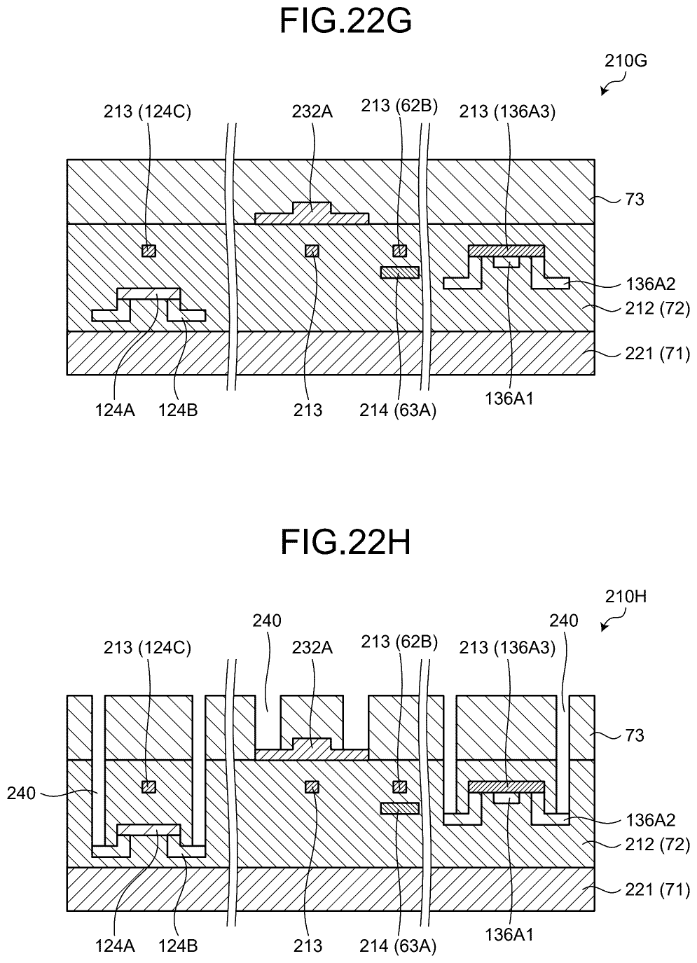

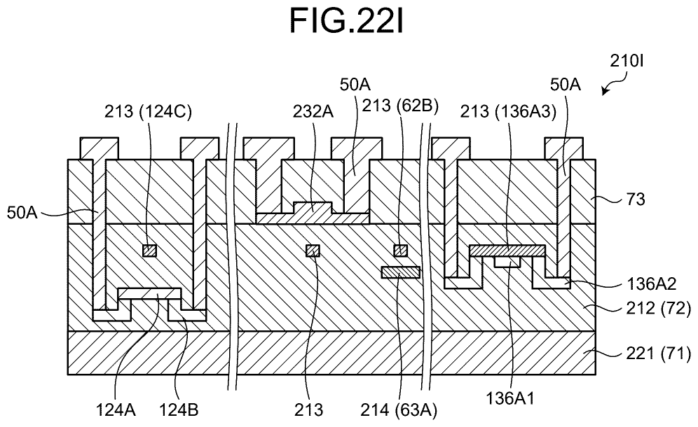

FIG. 22A is a schematic cross-sectional view illustrating an example of an Si photonics substrate 210A that is subjected to a first formation process. The Si photonics substrate 210A includes an Si substrate 211 for Si photonics, a BOX layer 212 that is laminated on the Si substrate 211, an Si waveguide 213 that is arranged in the BOX layer 212, and a SiN waveguide 214 that is arranged in the BOX layer 212. The Si photonics substrate 210A includes the heater 124A that is used for the second DCPS 124 that is arranged in the BOX layer 212, and the first light receiving element 136A that is arranged in the BOX layer 212. The Si waveguide 213 includes the Si waveguide 124C of the second DCPS 124, the Si waveguide 213 of the second output-side high refractive index waveguide 62B of the optical modulator 1C, and the Si waveguide 136A3 of the first light receiving element 136A. The Si photonics substrate 210A includes the heater terminal 124B of the heater 124A and the PD terminals 136A2 of the first light receiving element 136A.

FIG. 22B is a schematic cross-sectional view illustrating an example of an Si photonics substrate 210B that is subjected to a second formation process. An Si substrate 221 for the support substrate is prepared. The Si photonics substrate 210A illustrated in FIG. 22A is flipped upside down, and the Si substrate 221 for the support substrate is bonded on a surface of the BOX layer 212, so that the Si photonics substrate 210B that is subjected to the second formation process illustrated in FIG. 22B is obtained. Meanwhile, the Si substrate 221 is illustrated as an example of the support substrate; however, it may be possible to adopt a crystal substate with a low dielectric constant, and appropriate modification may be made. When a crystal substrate is adopted as the support substrate, the crystal substate is suitable for high-speed operation of the optical modulator 1C.

FIG. 22C is a schematic cross-sectional view illustrating an example of an Si photonics substrate 210C that is subjected to a first removal process. By removing the Si substrate 211 for Si photonics and a part of the BOX layer 212 on the Si substrate 211 for Si photonics from the Si photonics substrate 210B illustrated in FIG. 22B, the Si photonics substrate 210C that is subjected to the first removal process as illustrated in FIG. 22C is obtained. In this case, a surface of the BOX layer 212 is removed such that the Si waveguide is located at a close position of a several hundred nm from the surface of the BOX layer 212.

FIG. 22D is a schematic cross-sectional view illustrating an example of an Si photonics substrate 210D that is subjected to a third formation process. An LN-side Si substrate 231 in which a thin-film LN layer 232 is integrated is prepared. The thin-film LN layer 232 on the LN-side Si substrate 231 is bonded on the surface of the BOX layer 212 of the Si photonics substrate 210C illustrated in FIG. 22C, so that the Si photonics substrate 210D that is subjected to the third formation process illustrated in FIG. 22D is obtained. In the previous process, the Si waveguide is located at a position close to the surface of the BOX layer 212, so that it is possible to reduce a difference between the thin-film LN waveguide that is the thin-film LN layer 232 and the Si waveguide and simplify optical coupling.

FIG. 22E is a schematic cross-sectional view illustrating an example of an Si photonics substrate 210E that is subjected to a second removal process. By removing the LN-side Si substrate 231 from the Si photonics substrate 210D illustrated in FIG. 22D and performing polishing such that a thickness of the thin-film LN layer 232 reaches a predetermined thickness, such as about 500 nm, the Si photonics substrate 210E that is subjected to the second removal process as illustrated in FIG. 22E is obtained.

FIG. 22F is a schematic cross-sectional view illustrating an example of an Si photonics substrate 210F that is subjected to a fourth formation process. A rib waveguide 232A, for example, the first input-side arm waveguide 22 of the thin-film LN layer 232 is formed by performing dry etching on a part of the thin-film LN layer 232 on the BOX layer 212 on the Si photonics substrate 210E illustrated in FIG. 22E. As a result, the Si photonics substrate 210F that is subjected to the fourth formation process as illustrated in FIG. 22D is obtained.

FIG. 22G is a schematic cross-sectional view illustrating an example of an Si photonics substrate 210G that is subjected to a fifth formation process. By forming the upper clad layer 73 on the rib waveguide 232A in the thin-film LN layer 232 that is formed on the BOX layer 212 of the Si photonics substrate 210F illustrated in FIG. 22F, the Si photonics substrate 210G that is subjected to the fifth formation process as illustrated in FIG. 22G is obtained.

FIG. 22H is a schematic cross-sectional view illustrating an example of an Si photonics substrate 210H that is subjected to a sixth formation process. In the Si photonics substrate 210G illustrated in FIG. 22G, vias 240 for forming the electrode wiring 50A that is connected to the heater terminal 124B of the heater 124A, the slab of the rib waveguide 232A of the thin-film LN layer 232, and the PD terminals 136A2 of the first light receiving element 136A are formed. As a result, the Si photonics substrate 210H that is subjected to the sixth formation process as illustrated in FIG. 22H is obtained.

FIG. 22I is a schematic cross-sectional view illustrating an example of an Si photonics substrate 210I that is subjected to a seventh formation process. By forming the electrode wiring 50A by injecting an electrode material to each of the vias 240 of the Si photonics substrate 210I illustrated in FIG. 22I, the Si photonics substrate 210I that is subjected to the seventh formation process as illustrated in FIG. 22I is obtained.

In the optical transceiver 1E of the sixth embodiment, the optical modulator element 130A that includes the DP-IQ modulator 1D and the optical receiver element 130B are mounted by the silicon photonics technology, so that each of the optical modulators 1C is able to ensure the velocity matching and reduce a size of the folded portion. As a result, in the optical transceiver 1E on which the DP-IQ modulator 1D is mounted, it is possible to reduce a total chip size.

The optical modulator element 130A includes the DP-IQ modulator 1D in which the plurality of optical modulators 1C are incorporated. In addition, the DP-IQ modulator 1D is able to improve velocity mismatching while ensuring a long length of action, so that it is possible to reduce half-wave voltage Vn and it is possible to improve modulation efficiency of the DP-IQ modulator 1D.

Meanwhile, an embodiment of an optical module 1F on which the optical transceiver 1E of the sixth embodiment is mounted will be described below as a seventh embodiment.

### (g) Seventh Embodiment

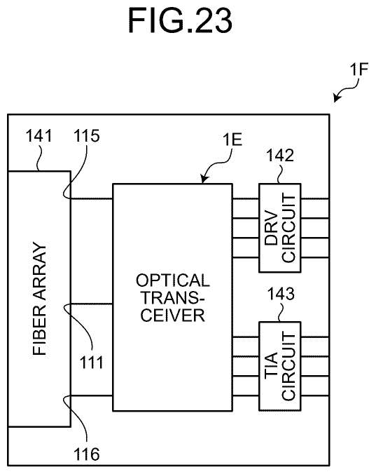

FIG. 23 is a diagram for explaining an example of a configuration of the optical module 1F of the seventh embodiment. Meanwhile, the same components as those of the optical transceiver 1E of the sixth embodiment are denoted by the same reference symbols, and explanation of the same components and the same operation will be omitted. The optical module 1F illustrated in FIG. 23 is a Coherent Optical Sub Assembly (COSA) that includes the optical transceiver 1E, a fiber array 141, a Driver (DRV) circuit 142, and a Transimpedance Amplifier (TIA) circuit 143.

The fiber array 141 is an array in which an optical fiber F2 that is connected to the transmission light output port 115, an optical fiber F1 that is connected to the LD input port 111, and an optical fiber F3 that is connected to the received light input port 116 are collectively connected.

The DRV circuit 142 is a drive circuit that applies an electrical signal to the signal electrode 51 in each of the optical modulators 1C. The TIA circuit 143 is an amplifier that amplifies an electrical signal that is obtained by electrical conversion performed by the first light receiving elements 136A and the second light receiving elements 136B, and outputs the amplified electrical signal.

The optical module 1F of the seventh embodiment includes the optical transceiver 1E in which the plurality of optical modulators 1C are incorporated, so that each of the optical modulators 1C is able to ensure the velocity matching and reduce a size of the folded portion. As a result, in the optical module 1F in which the optical transceiver 1E is incorporated, it is possible to reduce a total chip size.

Meanwhile, an embodiment of an optical transceiver 1G on which the optical module 1F of the seventh embodiment is mounted will be described below as an eighth embodiment.

### (h) Eighth Embodiment

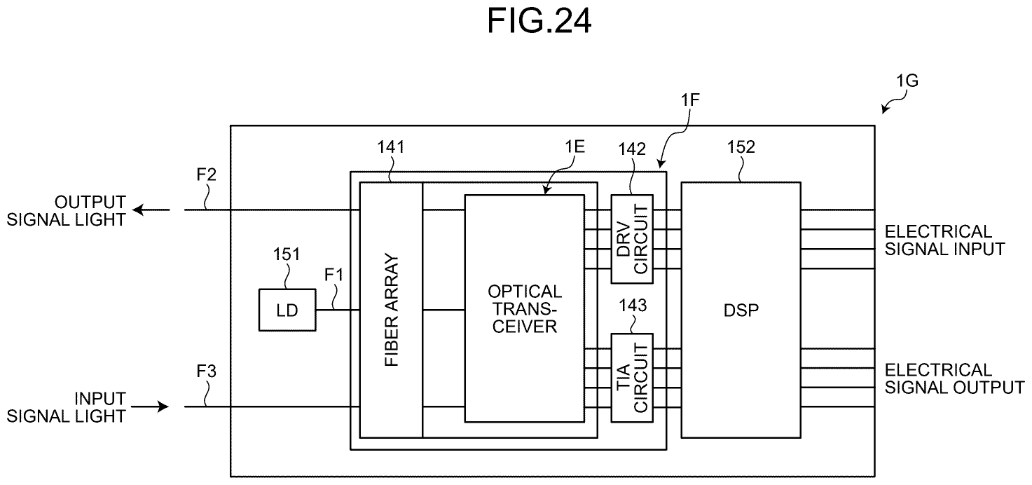

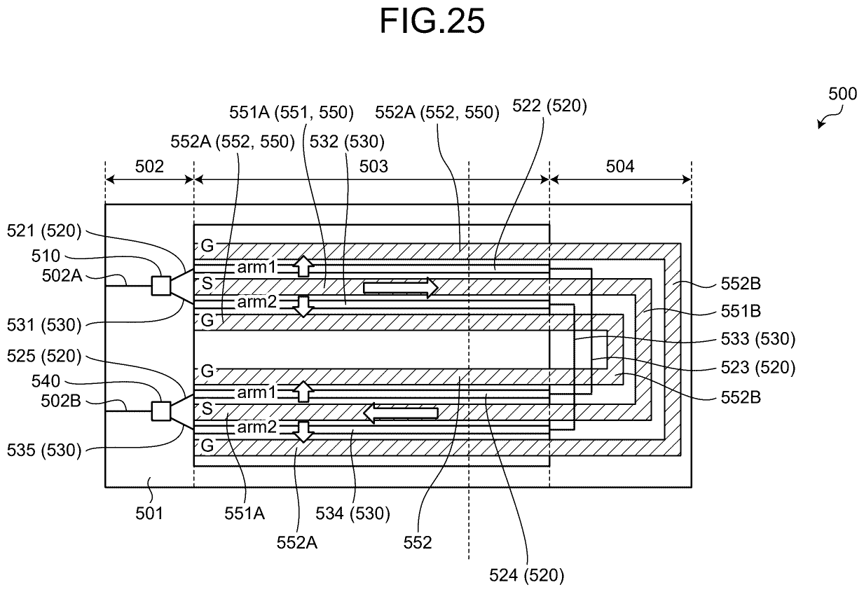

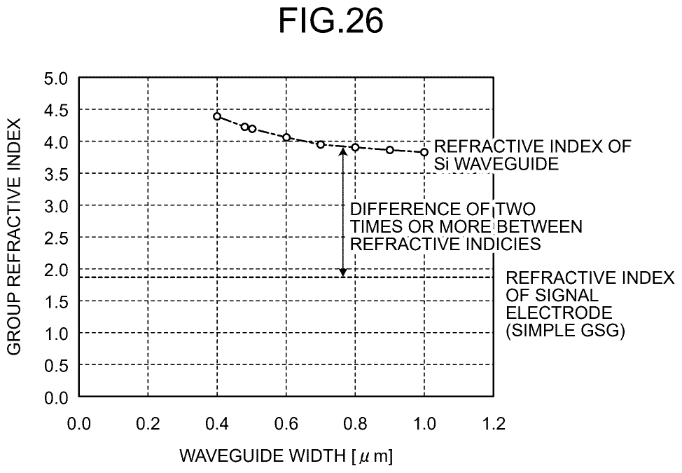

FIG. 24 is a diagram for explaining an example of the optical transceiver 1G of the eighth embodiment. The same components as those of the optical module 1F of the seventh embodiment are denoted by the same reference symbols, and explanation of the same components and the same operation will be omitted. The optical transceiver 1G illustrated in FIG. 24 includes a Laser Diode (LD) 151, the optical module 1F, and a Digital Signal Processor (DSP) 152. The optical transceiver 1G is a compact-size transceiver that is compliant with the QSFP stander, the OSFP standard, or the like. The LD 151 is a light source that emits laser light, for example. The optical module 1F includes the optical transceiver 1E, the DRV circuit 142, and the TIA circuit 143. The optical transceiver 1E includes the optical modulator element 130A and the optical receiver element 130B. The optical modulator element 130A is, for example, the DP-IQ modulator 1D or the like. The DSP 152 controls the entire optical transceiver 1E. The DSP 152 is an electrical component that performs digital signal processing, such as IQ modulation processing on a transmission signal and demodulation processing on a received signal.

The DSP 152 performs processing, such as encoding, on transmission data, generates an electrical signal that includes the transmission data, and outputs the generated electrical signal to the DRV circuit 142. The DRV circuit 142 drives the optical modulator element 130A in accordance with the electrical signal that comes from the DSP 152.

The optical receiver element 130B performs electrical conversion on signal light. The TIA circuit 143 amplifies an electrical signal that is subjected to the electrical conversion, and outputs the amplified electrical signal to the DSP 152. The DSP 152 performs processing, such as decoding, on the electrical signal that is obtained from the TIA circuit 143 and obtains received data.

Meanwhile, for the sake of simplicity of explanation, the example has been described in which the optical modulator element 130A and the optical receiver element 130B are incorporated in the optical transceiver 1G, but an optical transmission apparatus in which only the optical modulator element 130A is incorporated is applicable.

The optical transceiver 1G of the seventh embodiment includes the optical module 1F including the optical transceiver 1E in which the plurality of optical modulators 1C are incorporated. Each of the optical modulators 1C is able to ensure the velocity matching and reduce a size of the folded portion. As a result, in the optical transceiver 1G in which the optical module 1F is incorporated, it is possible to reduce a total size.

The components of each of the units illustrated in the drawings need not always be physically configured in the manner illustrated in the drawings. In other words, specific forms of distribution and integration of each of the units are not limited to those illustrated in the drawings, and all or part of the units may be functionally or physically distributed or integrated in arbitrary units depending on various loads or use conditions.

In addition, all or an arbitrary part of various kinds of processing functions that are implemented by the apparatuses may be realized by a Central Processing Unit (CPU) (or microcomputer, such as a Micro Processing Unit (MPU) or a Micro Controller Unit (MCU)). Furthermore, all or an arbitrary part of the various kinds of processing functions may be implemented by a program that is analyzed and executed by the CPU, or may be realized by hardware using wired logic.

According to one aspect, it is possible to ensure velocity matching and reduce a chip size of an optical modulator.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical modulator comprising:
a substrate that includes a high refractive index waveguide;
a first coupler that is arranged on the substrate and that splits signal light into two beams of light;
a first waveguide that is arranged on the substrate and that is connected to one output of the first coupler;
a second waveguide that is arranged on the substrate and that is connected to another output of the first coupler;
a second coupler that is arranged on the substrate, that couples signal light coming from the first waveguide and signal light coming from the second waveguide, and that outputs the coupled signal light; and
an electrode that applies an electrical signal to the first waveguide and the second waveguide, wherein
the first waveguide includes
a first input-side arm waveguide that is connected to the first coupler;
a first output-side arm waveguide that is connected to the second coupler; and
a first folded waveguide that connects between the first input-side arm waveguide and the first output-side arm waveguide,
the second waveguide includes
a second input-side arm waveguide that is connected to the first coupler;
a second output-side arm waveguide that is connected to the second coupler; and
a second folded waveguide that connects between the second input-side arm waveguide and the second output-side arm waveguide,
the first input-side arm waveguide, the second input-side arm waveguide, the first output-side arm waveguide, and the second output-side arm waveguide are waveguides that include a material with high EO characteristics as compared to the high refractive index waveguide, and
at least a part of the first folded waveguide and the second folded waveguide is a waveguide that includes a material with a low refractive index as compared to the high refractive index waveguide.

2. The optical modulator according to claim 1, wherein
the first waveguide includes
the first input-side arm waveguide that is located on an outer peripheral side of folding;
the first output-side arm waveguide that is located on an inner peripheral side of folding; and
a first folded waveguide that connects between the first input-side arm waveguide and the first output-side arm waveguide,
the second waveguide includes
the second input-side arm waveguide that is located on an inner peripheral side of folding;
the second output-side arm waveguide that is located on an outer peripheral side of folding; and
a second folded waveguide that connects between the second input-side arm waveguide and the second output-side arm waveguide.

3. The optical modulator according to claim 2, wherein
the first folded waveguide includes
a first input-side high refractive index waveguide that adopts a high refractive index layer on the substrate as a core layer and that is connected to the first input-side arm waveguide;
a first output-side high refractive index waveguide that adopts the high refractive index layer as a core layer and that is connected to the first output-side arm waveguide; and
a first low refractive index waveguide that adopts a first-stage low refractive index layer on the substrate as a core layer and that connects between the first input-side high refractive index waveguide and the first output-side high refractive index waveguide,
the second folded waveguide includes
a second input-side high refractive index waveguide that adopts the high refractive index layer as a core layer and that is connected to the second input-side arm waveguide;
a second output-side high refractive index waveguide that adopts the high refractive index layer as a core layer and that is connected to the second output-side arm waveguide; and
a second low refractive index waveguide that adopts the first-stage low refractive index layer as a core layer and that connects between the second input-side high refractive index waveguide and the second output-side high refractive index waveguide.

4. The optical modulator according to claim 3, wherein
the first low refractive index waveguide allows transition of the signal light with respect to the first input-side high refractive index waveguide and allows transition of the signal light with respect to the first output-side high refractive index waveguide,
the second low refractive index waveguide allows transition of the signal light with respect to the second input-side high refractive index waveguide and allows transition of the signal light with respect to the second output-side high refractive index waveguide, and
one of the first input-side high refractive index waveguide and the second output-side high refractive index waveguide crosses the low refractive index waveguide.

5. The optical modulator according to claim 2, wherein
the first folded waveguide includes
a first input-side high refractive index waveguide that adopts a high refractive index layer on the substrate as a core layer and that is connected to the first input-side arm waveguide;
a first output-side high refractive index waveguide that adopts the high refractive index layer as a core and that is connected to the first output-side arm waveguide;
a first input-side first-stage refractive index waveguide that adopts a first-stage low refractive index layer on the substrate as a core layer and that is connected to the first input-side high refractive index waveguide;
a first output-side first-stage refractive index waveguide that is formed on the first-stage low refractive index layer and that is connected to the first output-side high refractive index waveguide; and
a first second-stage low refractive index waveguide that adopts a second-stage low refractive index layer on the substrate as a core layer and that connects between the first input-side first-stage refractive index waveguide and the first output-side first-stage refractive index waveguide,
the second folded waveguide includes
a second input-side high refractive index waveguide that adopts the high refractive index layer as a core layer and that is connected to the second input-side arm waveguide;
a second output-side high refractive index waveguide that adopts the high refractive index layer as a core layer and that is connected to the second output-side arm waveguide;
a second input-side first-stage low refractive index waveguide that adopts the first-stage low refractive index layer as a core layer and that is connected to the second input-side high refractive index waveguide;
a second output-side first-stage low refractive index waveguide that adopts the first-stage low refractive index layer as a core layer and that is connected to the second output-side high refractive index waveguide; and
a second second-stage low refractive index waveguide that adopts the second-stage low refractive index layer as a core layer and that connects between the second input-side first-stage low refractive index waveguide and the second output-side first-stage low refractive index waveguide.

6. The optical modulator according to claim 5, wherein
the first second-stage low refractive index waveguide allows transition of the signal light with respect to the first input-side first-stage refractive index waveguide and allows transition of the signal light with respect to the first output-side first-stage refractive index waveguide,
the second second-stage low refractive index waveguide allows transition of the signal light with respect to the second input-side first-stage low refractive index waveguide and allows transition of the signal light with respect to the second output-side first-stage low refractive index waveguide, and
one of the first input-side high refractive index waveguide and the first output-side high refractive index waveguide crosses one of the first second-stage low refractive index waveguide and the second second-stage low refractive index waveguide.

7. The optical modulator according to claim 1, wherein
the first waveguide includes
the first input-side arm waveguide that is located on an outer peripheral side of folding;
the first folded waveguide that is located on an outer peripheral side of folding; and
the first output-side arm waveguide that is located on an outer peripheral side of folding, and
the second waveguide includes the second input-side arm waveguide that is located on an inner peripheral side of folding;
the second folded waveguide that is located on an inner peripheral side of folding; and
the second output-side arm waveguide that is located on an inner peripheral side of folding.

8. The optical modulator according to claim 7, wherein
the first folded waveguide includes
a first input-side high refractive index waveguide that adopts a high refractive index layer on the substrate as a core layer and that is connected to the first input-side arm waveguide;
a first output-side high refractive index waveguide that is formed on the high refractive index layer and that is connected to the first output-side arm waveguide; and
a first low refractive index waveguide that adopts a low refractive index layer on the substrate as a core layer and that connects between the first input-side high refractive index waveguide and the first output-side high refractive index waveguide, and
the second folded waveguide includes
a second input-side high refractive index waveguide that adopts the high refractive index layer as a core layer and that is connected to the second input-side arm waveguide;
a second output-side high refractive index waveguide that adopts the high refractive index layer as a core layer and that is connected to the second output-side arm waveguide; and
a second low refractive index waveguide that adopts the low refractive index layer as a core layer and that connects between the second input-side high refractive index waveguide and the second output-side high refractive index waveguide.

9. The optical modulator according to claim 3, wherein
the first input-side high refractive index waveguide, the first output-side high refractive index waveguide, the second input-side high refractive index waveguide, and the second output-side high refractive index waveguide are waveguides that adopt Si as cores, and
the first low refractive index waveguide and the second low refractive index waveguide are waveguides that adopt SiN as cores.

10. The optical modulator according to claim 1, wherein the material with high EO characteristics includes at least one of LiNbO₃, BaTiO₃, PZT, and PLZ.

11. The optical modulator according to claim 1, wherein the first waveguide and the second waveguide are folded an even number of times.

12. An optical transmitter comprising:
an optical modulator that modulates light that is guided in accordance with an electrical signal, wherein
the optical modulator includes
a substrate that includes a high refractive index waveguide;
a first coupler that is arranged on the substrate and that splits signal light into two beams of light;
a first waveguide that is arranged on the substrate and that is connected to one output of the first coupler;
a second waveguide that is arranged on the substrate and that is connected to another output of the first coupler;
a second coupler that is arranged on the substrate, that couples signal light coming from the first waveguide and signal light coming from the second waveguide, and that outputs the coupled signal light; and
an electrode that applies an electrical signal to the first waveguide and the second waveguide,
the first waveguide includes
a first input-side arm waveguide that is connected to the first coupler;
a first output-side arm waveguide that is connected to the second coupler; and
a first folded waveguide that connects between the first input-side arm waveguide and the first output-side arm waveguide,
the second waveguide includes
a second input-side arm waveguide that is connected to the first coupler;
a second output-side arm waveguide that is connected to the second coupler; and
a second folded waveguide that connects between the second input-side arm waveguide and the second output-side arm waveguide,
the first input-side arm waveguide, the second input-side arm waveguide, the first output-side arm waveguide, and the second output-side arm waveguide are waveguides that include a material with high EO characteristics as compared to the high refractive index waveguide, and
at least a part of the first folded waveguide and the second folded waveguide is a waveguide that includes a material with a low refractive index as compared to the high refractive index waveguide.

13. An optical transceiver comprising:
an optical modulator that modulates light that is guided in accordance with an electrical signal;
an optical receiver that converts received signal light to an electrical signal; and
a signal processor that generates an electrical signal to be output to the optical modulator and performs processing on an electrical signal that is obtained from the optical receiver, wherein
the optical modulator includes
a substrate that includes a high refractive index waveguide;
a first coupler that is arranged on the substrate and that splits signal light into two beams of light;
a first waveguide that is arranged on the substrate and that is connected to one output of the first coupler;
a second waveguide that is arranged on the substrate and that is connected to another output of the first coupler;
a second coupler that is arranged on the substrate, that couples signal light coming from the first waveguide and signal light coming from the second waveguide, and that outputs the coupled signal light; and
an electrode that applies an electrical signal to the first waveguide and the second waveguide, and
the first waveguide includes
a first input-side arm waveguide that is connected to the first coupler;
a first output-side arm waveguide that is connected to the second coupler; and
a first folded waveguide that connects between the first input-side arm waveguide and the first output-side arm waveguide,
the second waveguide includes
a second input-side arm waveguide that is connected to the first coupler;
a second output-side arm waveguide that is connected to the second coupler; and
a second folded waveguide that connects between the second input-side arm waveguide and the second output-side arm waveguide,
the first input-side arm waveguide, the second input-side arm waveguide, the first output-side arm waveguide, and the second output-side arm waveguide are waveguides that include a material with high EO characteristics as compared to the high refractive index waveguide, and
at least a part of the first folded waveguide and the second folded waveguide is a waveguide that includes a material with a low refractive index as compared to the high refractive index waveguide.
